(19) United States
(12) Patent Application Publication
(10) Pub. No.: US 2024/0422092 A1
(43) Pub. Date: Dec. 19, 2024

(54) Optimal Encoding Multicast Tree using Link Number and Bit

(71) Applicant: Huawei Technologies Co., Ltd., Shenzhen (CN)

(72) Inventor: Huaimo Chen, Bolton, MA (US)

(21) Appl. No.: 18/818,356

(22) Filed: Aug. 28, 2024

Related U.S. Application Data
(63) Continuation of application No. PCT/US2023/060158, filed on Jan. 5, 2023.
(60) Provisional application No. 63/314,582, filed on Feb. 28, 2022.

(51) Int. Cl. H04L 45/16; H04L 45/48; H04L 45/745

(52) U.S. Cl. CPC H04L 45/16; H04L 45/48; H04L 45/745

(57) ABSTRACT

A method implemented by an ingress node in a traffic engineering (TE) multicast domain along a point-to-multipoint (P2MP) path. The method includes receiving a packet from a traffic source; encapsulating the packet with a multicast routing header (MRH) for a sub-tree of the P2MP path through the TE multicast domain, wherein the MRH indicates the sub-tree by encoding link information of one or more links on the sub-tree, the link information of the one or more links comprising a link number of a link from the ingress node to a next hop node or a link bit indicating whether the link corresponding the link number is on the sub-tree; and sending the packet with the MRH toward the next hop node along the sub-tree.

### CROSS-REFERENCE TO RELATED APPLICATIONS

This patent application is a continuation of International Application No. PCT/US2023/060158 filed on Jan. 5, 2023, by Futurewei Technologies, Inc., and titled “Optimal Encoding Multicast Tree using Link Number and Bit,” which claims the benefit of U.S. Provisional Patent Application No. 63/314,582 filed Feb. 28, 2022 by Futurewei Technologies, Inc., and titled “Optimal Encoding Multicast Tree using Link Number and Bit,” which are hereby incorporated by reference in their entirety.

### TECHNICAL FIELD

The present disclosure is generally related to the field of network communication and, in particular, to multicast routing header with a point-to-multipoint (P2MP) path.

### BACKGROUND

In computer networking, multicast is group communication where data transmission is addressed to a group of destination computers simultaneously. Multicast can be one-to-many or many-to-many distribution. The one-to-many configuration is known as P2MP.

Bit Index Explicit Replication (BIER) mechanisms provide optimized forwarding of multicast data packets through a BIER domain. Traffic Engineering (TE) is the process of steering traffic across to a telecommunications network to facilitate efficient use of available bandwidth between a pair of routers. BIER Traffic/Tree Engineering (BIER-TE) is described in IETF document “Tree Engineering for Bit Index Explicit Replication (BIER-TE)” by T. Eckert, et al., published Jul. 9, 2021. Existing techniques for BIER-TE are not suitable for a BIER-TE path with multiple sets of bitstrings (a.k.a., BitStrings, bit strings, bit positions, etc.). For example, the existing BIER-TE header is only able to accommodate one set of bitstrings.

### SUMMARY

The disclosed aspects/embodiments describe a stateless multicast traffic engineering (TE) along a point-to-multipoint (P2MP) path/tree using a TE multicast routing header (MRH) (e.g., an Internet Protocol version six (IPv6) extension header). The MRH with the P2MP path may be encoded using at least one of link numbers or link bits, and added into a routing packet to improve the overhead and efficiency of multicast TE.

A first aspect relates to a method implemented by an ingress network node in a TE multicast domain along a P2MP) path, comprising: receiving a packet from a traffic source; encapsulating the packet with a MRH for a sub-tree of the P2MP path through the TE multicast domain, wherein the MRH indicates the sub-tree by encoding link information of one or more links on the sub-tree, with the link information of the one or more links comprising a link number of a link from the ingress node to a next hop node or a link bit indicating whether the link corresponding the link number is on the sub-tree; and sending the packet with the MRH toward the next hop node along the sub-tree.

Optionally, in any of the preceding aspects, another implementation of the aspect further comprises determining address of the next hop node from a neighbor address table using the link number of the link, wherein the neighbor address table comprises the address of the next hop node that is a media access control (MAC) address or an IPV6 address.

Optionally, in any of the preceding aspects, another implementation of the aspect provides the MRH comprises at least one of a link number (Link-No) field for indicating the link number of the link or a link bits field having link bits corresponding to respective link numbers of links, and wherein the link bits indicate whether the links corresponding to the respective link numbers are on the sub-tree.

Optionally, in any of the preceding aspects, another implementation of the aspect provides the MRH further comprises at least one of a number of branches (N-Branches) field for indicating the number of branches from the next hop node of the link along the sub-tree, a size of branches (S-Branches) field, or a field for indicating a pointer pointing to the sub-tree.

Optionally, in any of the preceding aspects, another implementation of the aspect provides the MRH further comprises an L flag indicating whether the next hop node of the link is a leaf node.

Optionally, in any of the preceding aspects, another implementation of the aspect provides the MRH further comprises a B flag with a value indicating that the link bits are used to represent the link information.

Optionally, in any of the preceding aspects, another implementation of the aspect provides the MRH comprises a flag with a value indicating the link directly from a root of the sub-tree is encoded by the link bits.

Optionally, in any of the preceding aspects, another implementation of the aspect provides the link bits field comprises a Bits field having multiple bits corresponding to respective link numbers, a Plus (P) field with a value indicating that a bit with a first value in the Bits field means a corresponding link is on a branch and the next hop node is a leaf node, and a size of the bits (S-Bits) field indicating a size of the Bits field in a unit.

A second aspect relates to a method implemented by a transit node in a TE multicast domain along a P2MP path, comprising: receiving a packet with a MRH and a destination address (DA), wherein the MRH indicates a sub-tree from the transit node by encoding first link information of one or more first links on the sub-tree, with the first link information of the one or more first links comprising a first link number of a first link from the transit node or a link bit indicating whether the first link corresponding the first link number is on the sub-tree; duplicating a copy of the packet for the sub-tree and determining a next hop node in accordance with the MRH; and sending the copy of the packet toward the next hop node along the sub-tree.

Optionally, in any of the preceding aspects, another implementation of the aspect provides sending the copy of the packet toward the next hop node along the sub-tree comprises sending the copy of the packet with an updated MRH toward the next hop node along the sub-tree, with the updated MRH comprising second link information of one or more second links determined in accordance with the MRH.

Optionally, in any of the preceding aspects, another implementation of the aspect further comprising setting a DA of the copy of the packet to address of the next hop node from a neighbor address table using the first link number of the first link from the transit node to the next hop node, wherein the neighbor address table comprises the address of the next hop node that is a MAC address or an IPv6 address.

Optionally, in any of the preceding aspects, another implementation of the aspect provides the MRH comprises at least one of a link number (Link No) field for indicating a link number of a link or a link bits field having multiple bits corresponding to respective link numbers of links, and wherein the multiple bits indicate whether the links corresponding to the respective link numbers are on the sub-tree.

Optionally, in any of the preceding aspects, another implementation of the aspect provides the MRH further comprises at least one of a number of branches (N-Branches) field for indicating the number of branches, a size of branches (S-Branches) field, or a field for indicating a pointer pointing to the sub-tree.

Optionally, in any of the preceding aspects, another implementation of the aspect provides the MRH comprises an L flag with a value indicating that the next hop node is a leaf node and has no corresponding N-Branches field and corresponding S-Branches field.

Optionally, in any of the preceding aspects, another implementation of the aspect provides the first link information further includes a B flag with a value indicates that link bits of the link bits field are used to represent the link information.

Optionally, in any of the preceding aspects, another implementation of the aspect provides the link bits field comprises a Bits field having multiple bits corresponding to respective link numbers, a Plus (P) field with a value indicating that a bit with a first value in the Bits field means a corresponding link is on a branch and the next hop node is a leaf node, and a size of the bits (S-Bits) field with a value indicating a size of the Bits field in a unit.

A third aspect relates to an ingress node in a TE multicast domain along a P2MP path, comprising: a memory storing instructions; and a processor coupled to the memory, the processor configured to execute the instructions to cause the ingress node to execute one or more of the disclosed embodiments.

A fourth aspect relates to a transit node in a TE multicast domain along a P2MP path, comprising: a memory storing instructions; and a processor coupled to the memory, the processor configured to execute the instructions to cause the transit node to execute one or more of the disclosed embodiments.

A fifth aspect relates to a non-transitory computer readable medium comprising a computer program product for use by an ingress network node, the computer program product comprising computer executable instructions stored on the non-transitory computer readable medium that, when executed by one or more processors, cause the ingress network node to execute one or more of the disclosed embodiments.

A sixth aspect relates to a non-transitory computer readable medium comprising a computer program product for use by a transit node, the computer program product comprising computer executable instructions stored on the non-transitory computer readable medium that, when executed by one or more processors, cause the transit node to execute one or more of the disclosed embodiments.

A seventh aspect relates to an ingress network node in a TE multicast domain along a P2MP path, comprising means for executing one or more of the disclosed embodiments.

An eighth aspect relates to a transit node in a TE multicast domain along a P2MP path, comprising means for executing one or more of the disclosed embodiments.

For the purpose of clarity, any one of the foregoing embodiments may be combined with any one or more of the other foregoing embodiments to create a new embodiment within the scope of the present disclosure.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of a network topology including a TE multicast domain along a P2MP path according to an embodiment of the disclosure.

FIG. 2A is a neighbor address table of a network node in the TE multicast domain according to an embodiment of the disclosure.

FIG. 2B is a neighbor address table of a network node in the TE multicast domain according to an embodiment of the disclosure.

FIG. 2C is a neighbor address table of an egress node in the TE multicast domain according to an embodiment of the disclosure.

FIG. 2D is a neighbor address table of an egress node in the TE multicast domain according to an embodiment of the disclosure.

FIG. 3A is a schematic diagram of a network topology including a TE multicast domain along a P2MP path including a broadcast link according to an embodiment of the disclosure.

FIG. 3B is a schematic diagram of a neighbor IPv6 address table of a network node in the TE multicast domain including the broadcast link according to an embodiment of the disclosure.

FIG. 3C is a schematic diagram of a network topology including a TE multicast domain along a P2MP path including a pseudo node according to an embodiment of the disclosure according to an embodiment of the disclosure.

FIG. 3D is a schematic diagram of a neighbor IPv6 address table of a network node in the TE multicast domain including the pseudo node according to an embodiment of the disclosure.

FIG. 3E is a schematic diagram of a neighbor IPv6 address table of a network node in the TE multicast domain including the pseudo node according to an embodiment of the disclosure.

FIG. 4A is an encoding sub-tree from a transit node via another transit node to egress nodes according to an embodiment of the disclosure.

FIG. 4B is an encoding sub-tree from a transit node via another transit node to egress nodes using an L flag according to an embodiment of the disclosure.

FIG. 4C is an encoding sub-tree from a transit node via another transit node to egress nodes using an L flag and a B flag according to an embodiment of the disclosure.

FIG. 4D is an encoding P2MP tree from an ingress node via transit nodes to egress nodes using an L flag and a B flag according to an embodiment of the disclosure.

FIG. 5A is a schematic diagram of a network topology including a TE multicast domain along a P2MP path according to an embodiment of the disclosure.

FIG. 5B is an encoding sub-tree from a transit node via another transit node to egress nodes using an L flag and a B flag according to an embodiment of the disclosure.

FIG. 5C is an encoding sub-tree from a transit node via another transit node to egress nodes using an L flag and a B flag according to an embodiment of the disclosure.

FIG. 6 is an encoding P2MP tree from an ingress node via transit nodes to egress nodes using an L flag and a B flag according to an embodiment of the disclosure.

FIG. 7A is a link number (Link-No) field of a link with an E flag set to a first value according to an embodiment of the disclosure.

FIG. 7B is a link number field of a link with the E flag set to a second value according to an embodiment of the disclosure.

FIG. 7C is a size of branches (S-Branches) field of a link with an E flag set to a first value according to an embodiment of the disclosure.

FIG. 7D is a S-Branches field of a link with an E flag set to a second value according to an embodiment of the disclosure.

FIG. 7E is a link number field of a link having an extended field according to an embodiment of the disclosure.

FIG. 7F is a link number field of a link having two extended fields according to an embodiment of the disclosure.

FIG. 8A is an encoding P2MP tree from an ingress node via transit nodes to egress nodes using an L flag, a B flag, and an E flag according to an embodiment of the disclosure.

FIG. 8B is an encoding P2MP tree from an ingress node via transit nodes to egress nodes using an L flag, a B flag, and an E flag according to an embodiment of the disclosure.

FIG. 8C is an encoding P2MP tree from an ingress node via transit nodes to egress nodes using an L flag, a B flag, and an E flag according to an embodiment of the disclosure.

FIG. 9 is an example format of an MRH in a routing packet according to an embodiment of the disclosure.

FIG. 10A is an encoding sub-tree from an ingress node via a transit node to egress nodes using an L flag and a B flag, and an MRH in a routing packet according to an embodiment of the disclosure.

FIG. 10B is an encoding sub-tree from a transit node to egress nodes using an L flag and a B flag, and an MRH in a routing packet according to an embodiment of the disclosure.

FIG. 10C is an encoding sub-tree from a network node via a transit node to egress nodes using an L flag and a B flag, and an MRH in a routing packet according to an embodiment of the disclosure.

FIG. 10D is an encoding sub-tree from a transit node to egress nodes using an L flag and n B flag, and an MRH in a routing packet according to an embodiment of the disclosure.

FIG. 10E is processing a routing packet with header length set to a first value according to an embodiment of the disclosure.

FIG. 10F is processing a routing packet without MRH according to an embodiment of the disclosure.

FIG. 11 is an encoding sub-tree from an ingress node via a transit node to egress nodes using an L flag and a B flag, and an MRH in a routing packet according to an embodiment of the disclosure.

FIG. 12A is an example format of an MRH in a routing packet according to an embodiment of the disclosure.

FIG. 12B is an example format of an MRH in a routing packet according to an embodiment of the disclosure.

FIG. 12C is an example format of an MRH in a routing packet with a B flag according to an embodiment of the disclosure.

FIG. 13A is an encoding sub-tree from a network node via a transit node to egress nodes using an L flag and a B flag, and an MRH in an IPV6 routing packet according to an embodiment of the disclosure.

FIG. 13B is an encoding sub-tree from a transit node to egress nodes using an L flag and a B flag, and an MRH in an IPV6 routing packet according to an embodiment of the disclosure.

FIG. 13C is an encoding sub-tree from a transit node to egress nodes using an L flag and a B flag, and an MRH in an IPV6 routing packet according to an embodiment of the disclosure.

FIG. 13D is an encoding sub-tree from a transit node to egress nodes using an L flag and a B flag, and an MRH in an IPV6 routing packet according to an embodiment of the disclosure.

FIG. 13E is an encoding sub-tree from a transit node to egress nodes using an L flag and a B flag, and an MRH in an IPV6 routing packet according to an embodiment of the disclosure.

FIG. 14 is an encoding sub-tree from an ingress node via a transit node to egress nodes using an L flag and a B flag, and an MRH in a routing packet according to an embodiment of the disclosure.

FIG. 15A is an example format of a segment routing header (SRH) in a routing packet according to an embodiment of the disclosure.

FIG. 15B is an example format of an SRH in a routing packet according to an embodiment of the disclosure.

FIG. 15C is an example format of an Internet Protocol (IP) header in a routing packet according to an embodiment of the disclosure.

FIG. 16 is a method implemented by an ingress node in the TE multicast domain along a P2MP path according to an embodiment of the disclosure.

FIG. 17 is a method implemented by a transit node in the TE multicast domain along a P2MP path according to an embodiment of the disclosure.

FIG. 18 is a schematic diagram of a network apparatus according to an embodiment of the disclosure.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

For BIER-TE, a BIER-TE “packets BitString” indicates the edges of the (loop-free) tree across which the packets are forwarded by BIER-TE. Existing techniques for BIER-TE are not suitable for a BIER-TE path with multiple sets of bitstrings (a.k.a., BitStrings, bit strings, bit positions, etc.). For example, the existing BIER-TE header is only able to accommodate one set of bitstrings. Thus, the existing BIER-TE header will not work for a BIER-TE path with more than one set of bitstrings. This causes inefficiency and leads to difficulties in computing and setting up paths (e.g., P2MP paths) through the BIER-TE domain.

Furthermore, a segment routing header (SRH) with multicast SIDs encoding an SR P2MP path is relatively large. This is due to the size of the multicast SIDs, which are 128 bits each. The size of the multicast SIDs in the SRH increases the overhead of SR multicast, which decreases the efficiency of SR multicast.

Disclosed herein are techniques that describe a stateless multicast TE along an explicit P2MP path/tree using an IPV6 extension header called TE MRH. The MRH with the path encoded in link numbers and/or link bits is added into a packet to be multicast at the ingress to decrease the overhead and to increase the efficiency of multicast TE relative to existing techniques.

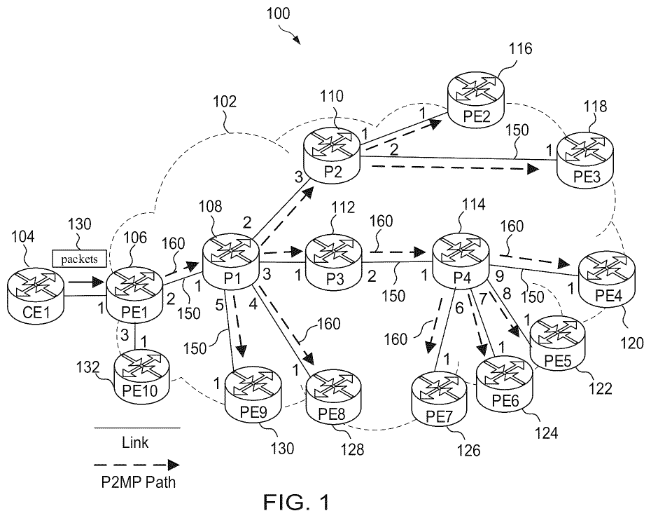

FIG. 1 is a schematic diagram of a network topology 100 including a TE multicast domain 102 along a P2MP path. The TE multicast domain 102 receives packets 130 from a content source 104. The content source 104 may be a network node, a server, a data center, or other telecommunications device configured to receive and respond to requests for content. The TE multicast domain 102 comprises a plurality of network nodes 106, 108, 110, 112, 114, 116, 118, 120, 122, 124, 126, 128, 130, and 132. While fourteen network nodes 106-132 are shown in the TE multicast domain 102, more or fewer nodes may be included in practical applications.

Each of the network nodes 106-132 may comprise a router, switch, or other telecommunications device configured to receive, route, store, and transmit packets 130. Some of the network nodes, namely the network nodes 106, 116, 118, 120, 122, 124, 126, 128, 130, and 132 are disposed at an edge of the TE multicast domain 102. The network nodes 106, 112, 114, 120, 122, 124, 126, 128, 130, and 132 receiving multicast packets from outside the TE multicast domain 102 may be referred to as an ingress node (or an ingress network node). The nodes 106, 116, 118, 120, 122, 124, 126, 128, 130, and 132 transmitting multicast packets out of the TE multicast domain 102 may be referred to as an egress node (or an egress network node). Depending on the direction of multicast packet traffic, each of the network nodes 106, 116, 118, 120, 122, 124, 126, 128, 130, and 132 may function as an ingress node or an egress node. The network nodes 108, 110, 112, and 114 forwarding multicast packets in the TE multicast domain 102 may be referred to as a transit node.

For case of reference, the various network nodes have been given a letter and number designation. For example, the content source 104 is designated CE1, the network node 106 is designated PE1, the network node 108 is designated P1, and so on.

The content source 104 and network nodes 106-132 in FIG. 1 are coupled to, and communicate with each other, via links 150. The links 150 may be wired, wireless, or some combination thereof. In an embodiment, each of the links 150 may have a cost. The cost of each of the links 150 may be the same or different, depending on the network topology 100 and the conditions therein.

Using the various links 150, an P2MP path 160 may be established through the TE multicast domain 102. The P2MP path 160 is used to distribute the packets 130 within the TE multicast domain 102 to the entity or device (not shown) that requested the content included in the packets 130.

The network nodes 106-132 in FIG. 1 are designated PE1, P1 to P4, and PE2 to PE10. In an embodiment, each link 150 connected to a network node 106-132 in the TE multicast domain 102 is assigned a local link number (or simply, a link number). In an example, PE1 has three links: link from PE1 to CE1, link from PE1 to P1, and link from PE1 to PE10. These three links of PE1 are assigned link numbers 1, 2, and 3, respectively. In another example, P1 has five links: link from P1 to PE1, link from P1 to P2, link from P1 to P3, link from P1 to PE8, and link from P1 to PE9. These five links of P1 are assigned link numbers 1, 2, 3, 4, and 5, respectively. In another example, P3 has two links: link from P3 to P1 and link from P3 to P4. These two links of P3 are assigned link numbers 1 and 2, respectively. That is, each link connected to a network node 106-132 in the TE multicast domain 102 may be assigned a link number.

In another embodiment, each link connected to a network node 106-132 in the TE multicast domain 102 may be represented by the link numbers and/or link bits along the P2MP path 160. For example, PE1's link number is 2, P1's link bits represent link numbers 2, 3, 4 and 5, P2's link numbers are 1 and 2, P3's link number is 2, and P4's link bits represent link numbers 6, 7, 8 and 9. As such, link bits are used when encoding a part of the branches (a.k.a, sub-trees/links) from a node is more efficient; otherwise, the link numbers are used.

When a node (e.g., network node 106) receives a packet (e.g., one of the packets 130), the node duplicates the packet received from an incoming interface and delivers the duplicated packet to each of the multiple outgoing interfaces along the TE P2MP path 160. The TE P2MP path 160 may be referred to as the TE P2MP tree, each segment of the TE P2MP tree from a node via a link towards the egress nodes of the TE P2MP tree may be referred to as a branch or a sub-tree, and each egress node may be referred to as a leaf (or one of the leaves).

For a packet 130 received by the ingress node 106, the ingress node 106 encapsulates the packet 130 with an MRH including a P2MP path 160 represented by the link numbers and/or links bits along the P2MP path 160. When a network node 106-132 receives the packet 130 with the MRH, the node may get/pops each of the node's own link numbers and finds the address of a next hop node from a neighbor table using the link number. For example, when P1 receives the packet with link number 3, P1 sends the packet to the next hop node such as P3.

The packet 130 received from the multicast source (e.g., network node 104 designated CE1) is imported into the TE P2MP path 160 at the ingress node 106 and sent to the egress nodes 116-132 of the TE P2MP path 160 along the TE P2MP path 160. For example, in FIG. 1, the packet 130 from the multicast source is imported into the TE P2MP path 160 at the ingress node 106 (PE1) and sent to the egress nodes 116-132 (PE2 to PE10) along the TE P2MP path 160.

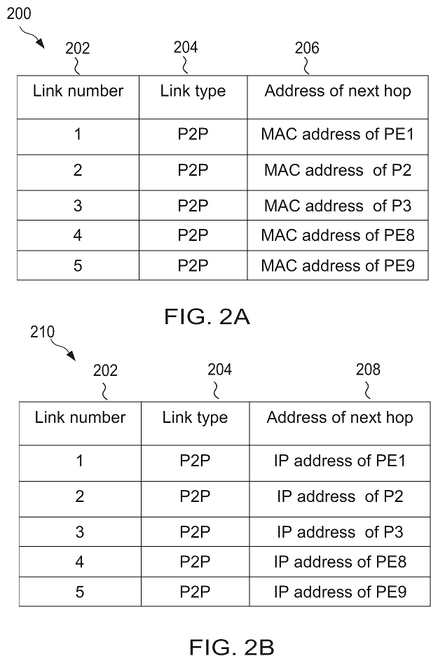

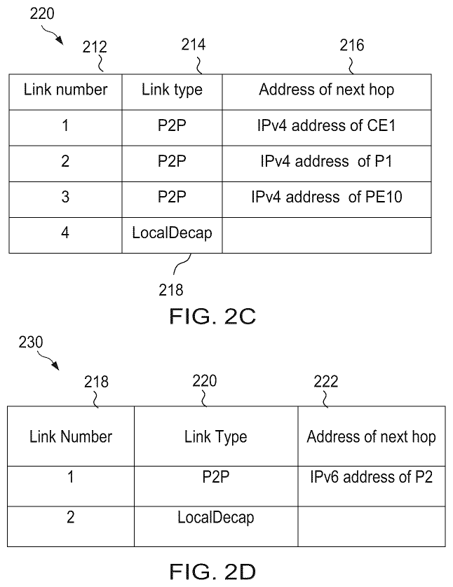

FIG. 2A is a neighbor address table 200 of a network node in the TE multicast domain. In an embodiment, the network node is P1 in FIG. 1. As shown, the neighbor address table 200 includes a link number field 202, a link type field 204, and an address of next hop field 206. The link number field 202 includes a link number of a link of P1, the link type field 204 includes a link type (such as Point to Point (P2P)) for link from P1 to a next hop, and the address of next hop field 206 includes a MAC address of the next hop. As shown in FIG. 1, P1 has five links, namely a link 150 from P1 to next hop node PE1, a link 150 from P1 to next hop P2, a link 150 from P1 to next hop node P3, a link 150 from P1 to next hop node PE8, and a link 150 from P1 to next hop node PE9. These five links 150 have local link numbers 1, 2, 3, 4, and 5, respectively on P1. The neighbor address table 200 comprises five rows. The first row comprises link number 1 (for the link 150 from P1 to next hop node PE1), link type P2P, and MAC address of PE1. The second row comprises link number 2 (for the link 150 from P1 to next hop node P2), link type P2P, and MAC address of P2. The third row comprises link number 3 (for the link 150 from P1 to next hop node P3), link type P2P, and MAC address of P3. The fourth row comprises link number 4 (for the link 150 from P1 to next hop node PE8), link type P2P, and MAC address of PE8. The fifth row comprises link number 5 (for the link 150 from P1 to next hop node PE9), link type P2P, and MAC address of PE9. Using link number 1, PE1's MAC address is obtained from the address table 200. Using link number 2, P2's MAC address is obtained from the address table 200. Using link number 3, P3's MAC address is obtained from the address table 200. Using link number 4, PE8's MAC address is obtained from the address table. Using link number 5, PE9's MAC address is obtained from the address table.

FIG. 2B is another neighbor address table of a network node in the TE multicast domain. In an embodiment, the network node is P1 in FIG. 1. As shown, the neighbor address table 210 includes a link number field 202, a link type field 204, and an address of next hop field 208. The link number field 202 includes a link number of a link of P1, the link type field 204 includes a link type (such as Point to Point (P2P)) for link from P1 to a next hop node, and the address of next hop field 208 includes an Internet Protocol (IP) address of the next hop node of P1. The IP address may be one of an IPV4 address or an IPV6 address. As shown in FIG. 1, P1 has five links, namely a link 150 from P1 to next hop node PE1, a link 150 from P1 to next hop node P2, a link 150 from P1 to next hop node P3, a link 150 from P1 to next hop node PE8, and a link 150 from P1 to next hop node PE9. These five links 150 have local link numbers 1, 2, 3, 4, and 5, respectively on P1. The address table 210 comprises five rows. The first row comprises link number 1 (for the link 150 from P1 to next hop node PE1), link type P2P, and IP address of PE1. The second row comprises link number 2 (for the link 150 from P1 to next hop node P2), link type P2P, and IP address of P2. The third row comprises link number 3 (for the link 150 from P1 to next hop node P3), link type P2P, and IP address of P3. The fourth row comprises link number 4 (for the link 150 from P1 to next hop node PE8), link type P2P, and IP address of PE8. The fifth row comprises link number 5 (for the link 150 from P1 to next hop node PE9), link type P2P, and IP address of PE9. Using link number 1, PE1's IP address is obtained from the table 210. Using link number 2, P2's IP address is obtained from the table 210. Using link number 3, P3's IP address is obtained from the table 210. Using link number 4, PE8's IP address is obtained from the table. Using link number 5, PE9's IP address is obtained from the table.

FIG. 2C is another neighbor address table of an egress node in the TE multicast domain according to an embodiment of the disclosure. For an egress node, a special multicast link (referred as a multicast loopback link or a multicast local decapsulation link) may be configured on the node. For example, the egress nodes are PE1 to PE10 in FIG. 1. A multicast local decapsulation link (or simply, local decap) is configured on each of these ten (i.e., PE1 to PE10) egress nodes. The link numbers of these local decap links are 3, 4, 2, 6, 7, 8, 5, and 3, respectively on the egress nodes PE1 to PE10.

In an embodiment, the egress node is PE1 in FIG. 1. As shown in FIG. 2C, the neighbor address table 220 includes a link number field 212, a link type field 214, and an address of next hop field 216. The link number field 212 includes a link number of a link of PE1, the link type field 214 includes a link type for link from PE1 to a next hop node, and the address of next hop field 216 includes an IPV4 address of a next hop node of PE1. As shown in FIG. 1, PE1 has three links, namely a link 150 from PE1 to next hop node CE1, a link 150 from PE1 to next hop node P1, and a link 150 from PE1 to next hop node PE10. These three links 150 have local link numbers 1, 2, and 3, respectively on PE1. The address table 220 comprises four rows. The first row comprises link number 1 (for the link 150 from PE1 to next hop CE1), link type P2P, and IPv4 address of CE1. The second row comprises link number 2 (for the link 150 from PE1 to next hop node P1), link type P2P, and IPv4 address of P1. The third row comprises link number 3 (for the link 150 from PE1 to next hop node PE10), link type P2P, and IPv4 address of PE10. The fourth row comprises link number 4, link type LocalDecap for the local decapsulation link of PE1, and address of next hop field is empty. Using link number 1, CE1's IPv4 address is obtained from the table 220. Using link number 2, P1's IPv4 address is obtained from the table 220. Using link number 3, PE10's IPv4 address is obtained from the table 220. Using link number 4, PE1 obtains a local decapsulation link from the table 220 and decapsulates the packet with link number 4.

FIG. 2D is another neighbor address table of an egress node in the TE multicast domain. In an embodiment, the egress node is PE2 in FIG. 1. As shown in FIG. 2D, the neighbor address table 230 includes a link number field 218, a link type field 220, and an address of next hop field 222. The link number field 218 includes a link number of a link of PE2, the link type field 220 includes a link type for link from PE2 to a next hop node, and the address of next hop field 222 includes an IPV6 address of a next hop node of PE2. As shown in FIG. 1, PE2 has one link, namely a link 150 from PE2 to next hop node P2 having local link number 1. The address table 230 comprises two rows. The first row comprises link number 1 (for the link 150 from PE2 to next hop node P2), link type P2P, and IPV6 address of P2. The second row comprises link number 2, link type LocalDecap for the local decapsulation link of PE2, and address of next hop field is empty. Using link number 1, P2's IPV6 address is obtained from the table 230. Using link number 2, PE2 obtains a local decapsulation link from the table 230 and decapsulates the packet with link number 2.

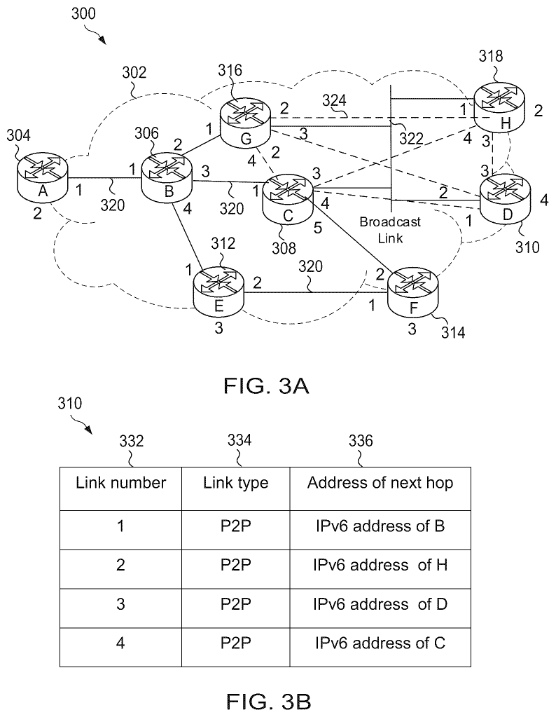

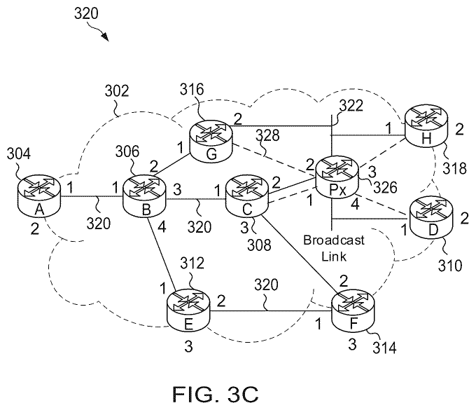

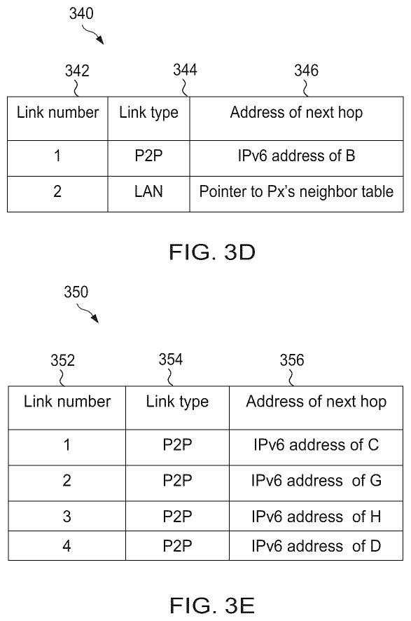

FIG. 3A is a schematic diagram of a network topology 300 including a TE multicast domain 302 along a P2MP path including a broadcast link according to an embodiment of the disclosure. The TE multicast domain 302 comprises a plurality of network nodes 304, 306, 308, 310, 312, 314, 316, and 318. While eight network nodes 304-318 are shown in the TE multicast domain 302, more or fewer nodes may be included in practical applications.

For case of discussion, all of the network nodes 304-318 have been given a letter designation. For example, the network node 304 has the designation A, the network node 306 has the designation B, the network node 308 has the designation C, the network node 310 has the designation D, the network node 312 has the designation E, the network node 314 has the designation F, the network node 316 has the designation G, and the network node 318 has the designation H.

Some of the network nodes, namely the network nodes A, D, E, F and H, are disposed at an edge of the TE multicast domain 302. The network nodes A, D, E, F and H receiving multicast packets from outside the TE multicast domain 302 may be referred to as an ingress node. The network nodes A, D, E, F and H transmitting multicast packets out of the TE multicast domain 302 may be referred to as an egress node. Depending on the direction of multicast packet traffic, each of the network nodes A-H may function as an ingress node or an egress node. The network nodes A-H in FIG. 3A are coupled to, and communicate with each other, via links 320. The links 320 may be wired, wireless, or some combination thereof. The network topology 300 further includes a broadcast link 322 (a.k.a., a local area network (LAN)). The broadcast link (a.k.a., LAN) 322 connects four network nodes C, D, G, and H in FIG. 3A. Furthermore, the network nodes C, D, G, and H are considered as they are connected to each other by P2P links 324. In one example, as shown in FIG. 3A, G has four links, namely a P2P link from G to B with local link number 1, a P2P link from G to H with local link number 2, a P2P link from G to D with local link number 3, and a P2P link from G to C with local link number 4. In another example, as shown in FIG. 3A, D has four links, namely a P2P link from D to C with local link number 1, a P2P link from D to G with local link number 2, a P2P link from D to H with local link number 3, and a local decap link with link number 4.

FIG. 3B is a schematic diagram of a neighbor address table of a network node in the TE multicast domain including the broadcast link. As shown in FIG. 3B, the neighbor address table 310 includes a link number field 332, a link type field 334, and an address of next hop field 336. The link number field 332 includes a link number of a link of G, the link type field 334 includes a link type for link from G to a next hop node, and the address of next hop field 336 includes an IPV6 address of a next hop node of G. As shown in FIG. 3A, G has four links, namely a P2P link from G to next hop node B with local link number 1, a P2P link from G to next hop node H with local link number 2, a P2P link from G to next hop node D with local link number 3, and a P2P link from G to next hop node C with local link number 4. The address table 310 comprises four rows. The first row comprises link number 1 (for the link from G to next hop node B), link type P2P, and IPv6 address of B. The second row comprises link number 2 (for the link from G to next hop node H), link type P2P, and IPv6 address of H. The third row comprises link number 3 (for the link from G to next hop node D), link type P2P, and IPV6 address of D. The fourth row comprises link number 4, link type P2P, and IPV6 address of C. Using link number 1, B's IPV6 address is obtained from the table 310. Using link number 2, H's IPV6 address is obtained from the address table 310. Using link number 3, D's IPv6 address is obtained from the address table 310. Using link number 4, C's IPV6 address is obtained from the address table 310.

FIG. 3C is a schematic diagram of a network topology 320 including a TE multicast domain 302 along a P2MP path including a pseudo node 326. The network topology 320 of FIG. 3C includes the pseudo node 326 (e.g., network node Px). The pseudo node 326 is represented as being disposed on the broadcast link 322 and having neighbor network nodes (i.e., next hop network nodes) including network node C, network node D, network node G, and network node H. The broadcast link (a.k.a., LAN) 322 connects four network nodes C, D, G, and H in FIG. 3B. Furthermore, the network nodes C, D, G, and H are connected to the pseudo node 326 by a LAN link, and the pseudo node 326 connects to C, D, G, and H by P2P links 328. In one example, as shown in. 3C, node G has a P2P link from G to B with link number 1, and LAN link from G to Px with link number 2. Node H has a LAN link from H to Px with link number 1, and a local decap link with link number 2. Node D has a LAN link from D to Px with link number 1, and a local decap link with link number 2. Node C has a P2P link from C to B with link number 1, a LAN link from C to Px with link number 2, and P2P link from C to F with link number 3. Node Px has four P2P links from Px to C, G, H, and D with link numbers 1, 2, 3, and 4, respectively.

FIG. 3D is a schematic diagram of a neighbor address table of a network node in the TE multicast domain including the pseudo node according to an embodiment of the disclosure. As shown in FIG. 3C, each of the four network nodes C, G, H and D is connected to Px 326. Each of the four network nodes C, G, H and D connected to Px has two neighbor address tables, a main neighbor address table of the node (C, G, H and D) and a secondary neighbor address table for Px 326. As shown in FIG. 3D, the neighbor address table 340 includes a link number field 342, a link type field 344, and an address of next hop field 346. The address table 340 comprises two rows. The first row comprises link number 1 (for the link from G to next hop node B), link type P2P for link from G to next hop node B, and IPv6 address of B. The second row comprises link number 2 (for the link from G to next hop node Px), link type LAN for link from G to next hop node Px, and a pointer to the secondary neighbor address table for Px.

FIG. 3E is a schematic diagram of a neighbor table of a network node in the TE multicast domain including the pseudo node. As shown in FIG. 3E, the neighbor address table 350 includes a link number field 352, a link type field 354, and an address of next hop field 356. The address table 350 comprises four rows. The first row comprises link number 1, link type P2P for link from Px to next hop node C, and C's IPV6 address. The second row comprises link number 2, link type P2P for link from Px to next hop node G, and G's IPV6 address. The third row comprises link number 3, link type P2P for link from Px to next hop node H, and H's IPV6 address. The fourth row comprises link number 4, link type P2P for link from Px to next hop node D, and D's IPV6 address.

For a multicast packet containing the P2MP path with a LAN link from a node such as node G to the pseudo node Px 326 for the LAN, the node sends the packet towards Px's next hop nodes on the P2MP path encoded in the packet. The node sends the packet to Px 326 according to the neighbor address table of the node and the LAN link from the node to Px. The node then acts as Px to send the packet to each of the Px's next hop nodes that are on the P2MP path using the secondary neighbor table for Px.

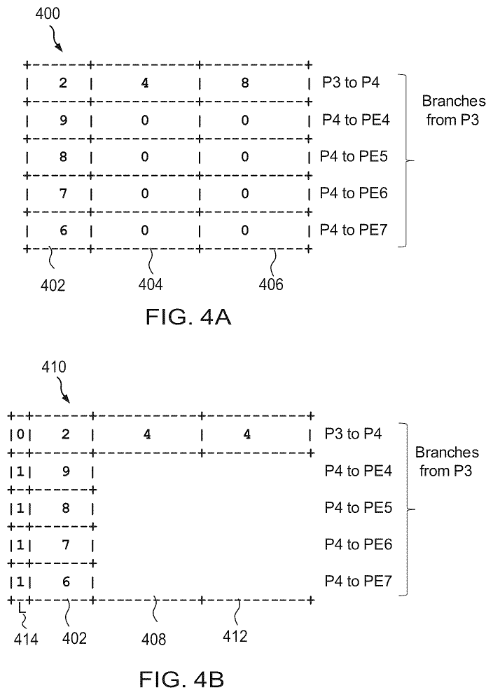

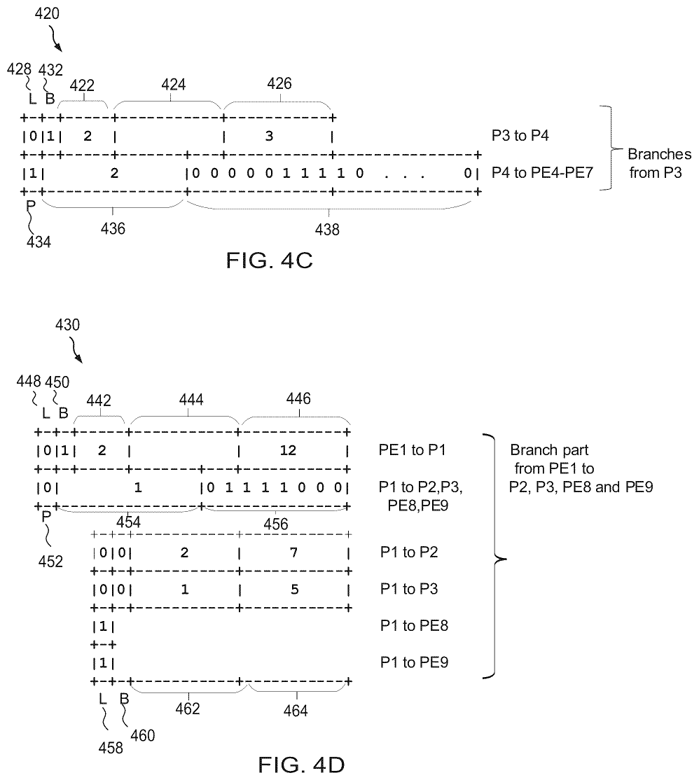

FIG. 4A is an encoding sub-tree from a transit node via another transit node to egress nodes. In the illustrated embodiment, the transit node is P3, the next hop node is P4, and the egress nodes are PE4 to PE7.

In an embodiment, the sub-tree from P3 via P4 towards PE4 to PE7 in FIG. 1 is represented in FIG. 4A using link numbers. In an embodiment, the encoding sub-tree 400 includes a link number (Link-No) field 402, a number of branches (N-Branches) field 404, and a size of branches (S-Branches) field 406. The Link-No field 402 includes a value indicating the link number of the link from the transmit node to the next hop node along the sub-tree, the N-Branches field 404 includes a value indicating the number of branches or next hops from a next hop node along the sub-tree, and the S-Branches field 406 includes a value indicating a size (in bytes) of the branches of the next hop node along the sub-tree and the fields following. As shown in FIG. 4A, for the link from P3 to next hop node P4, a Link-No field 402 with the value of 2 indicates the link number of the link, a N-Branches field 404 with the value of 4 indicates that there are 4 branches/links/sub-trees from next hop node P4, and a S-Branches field 406 with the value of 8 indicates a size of branches of node P4 along the sub-tree is 8 bytes.

For the link from P4 to PE4 (a leaf node/an egress node), a Link-No field 402 with the value of 9 indicates the link number of the link. The N-Branches field 404 and the S-Branches field 406 each have a value of 0 indicating there is no branch/link/sub-tree from node PE4.

For the link from P4 to PE5 (a leaf node/an egress node), a Link-No field 402 with the value of 8 indicates the link number of the link. The N-Branches field 404 and the S-Branches field 406 each have a value of 0 indicating there is no branch/link/sub-tree from node PE5.

For the link from P4 to PE6 (a leaf node/an egress node), a Link-No field 402 with the value of 7 indicates the link number of the link. The N-Branches field 404 and the S-Branches field 406 each have a value of 0 indicating there is no branch/link/sub-tree from node PE6.

For the link from P4 to PE7 (a leaf node/an egress node), a Link-No field 402 with the value of 6 indicates the link number of the link. The N-Branches field 404 and the S-Branches field 406 each have a value of 0 indicating there is no branch/link/sub-tree from node PE7.

FIG. 4B is an encoding sub-tree from a transit node via another transit node to egress nodes using an L flag according to an embodiment of the disclosure. In the illustrated embodiment, the transit node is P3, the next hop node is P4, and the egress nodes are PE4 to PE7.

In an embodiment, the sub-tree from P3 via P4 towards PE4 to PE7 in FIG. 1 is represented in FIG. 4B using link numbers. In an embodiment, the encoding sub-tree 410 includes a link number (Link-No) field 402, a number of branches (N-Branches) field 408, and a size of branches (S-Branches) field 412. The Link-No field 402 includes a value indicating the link number of the link from the transmit node to the next hop node along the sub-tree, the N-Branches field 408 includes a value indicating the number of branches of the next hop node along the sub-tree, and the S-Branches field 412 includes a value indicating a size of the branches of the next hop node along the sub-tree.

Relative to the encoding sub-tree 400 of FIG. 4A, the encoding sub-tree 410 of FIG. 4B is improved by using an L flag in the L flag field 414. When set to a particular value (e.g., 1), the L flag in the L flag field 414 indicates that the next hop node is a leaf node and, as such, the N-Branches field 408 and S-Branches field 412 have been removed.

For example, assume that the L flag field 414 and the link number field 402 occupy 1 byte, and that the N-Branches field 408 and S-Branches field 412 occupy another 1 byte. Keeping this in mind, the value of the L flag in the L flag field 414 for the link from P3 to P4 has a value of 0 (i.e., is set to zero). This indicates that P4 is not a leaf node. The link number field 402 has a value of 2 to indicate the link number of the link. The N-Branches field 408 has a value of 4 to indicate there are four branches/links/sub-trees from node P4. The S-Branches field 412 has a value of 4 to indicate a size of branches of node P4 along the sub-tree is 4 bytes. Thus, 6 bytes are used to encode the sub-tree from P3.

In contrast to the above, the value of the flag in the L flag field 414 for the link from P4 to PE4 has a value of 1 (i.e., is set to one). This indicates that PE4 is a leaf node (a.k.a., egress node). The link number field 402 has a value of 9 to indicate the link number of the link. However, because of the value of the L flag in the L flag field 414 is 1, the N-Branches field 408 and S-Branches field 412 have been removed. Thus, only 1 byte is used to encode this sub-tree from P4. Other sub-trees in FIG. 4B having an L flag in the L flag field 414 with a value of 1 also need only 1 byte to be encoded. Therefore, the encoding sub-tree 410 of FIG. 4B can be encoded using fewer bytes relative to the encoding sub-tree 400 of FIG. 4A.

FIG. 4C is an encoding sub-tree from a transit node via another transit node to egress nodes using an L flag and a B flag according to an embodiment of the disclosure. In the illustrated embodiment, the transit node is P3, the next hop node is P4, and the egress nodes are PE4 to PE7.

In an embodiment, the sub-tree from P3 via P4 towards PE4 to PE7 in FIG. 1 is represented in FIG. 4C using link numbers and/or link bits. In an embodiment, the encoding sub-tree 420 includes a link number (Link-No) field 422, a number of branches (N-Branches) field 424, and a size of branches (S-Branches) field 426. The Link-No field 422 includes a value indicating the link number of the link from the transmit node to the next hop node along the sub-tree, the N-Branches field 424 includes a value indicating the number of branches of the next hop node along the sub-tree, and the S-Branches field 426 includes a value indicating a size of the branches of the next hop node along the sub-tree.

Relative to the encoding sub-tree 410 of FIG. 4B, the encoding sub-tree 420 of FIG. 4C is improved by using an L flag in the L flag field 428 and B flag in B flag field 432. When set to a particular value (e.g., 1), the B flag in the B flag field 432 indicates that the link bits have been used to represent the link information. The link information may further represent other link related information such as whether next hops are leaves or not. The link bits field contain a plus (P) field 434 (or simply P field) field, size of the bits (S-Bits) field 436, and a Bits field 438.

For example, assume that the value of P field 434 for the link from P3 to P4 has a value of 1 (i.e., is set to one). This indicates that a bit with value of 1 in the Bits field is associated with a corresponding link on the branch and the next hop node is a leaf node. As shown in FIG. 1, P4 has four links, namely a link from P4 to next hop node PE7, a link from P4 to next hop PE6, a link from P4 to next hop node PE5, and a link from P4 to next hop node PE4. These four links 150 have local link numbers 6, 7, 8, and 9, respectively on P4 and are represented by the 6-th bit, 7-th bit, 8-th bit and 9-th bit in the Bits field 438 (from left to right), respectively.

The S-Bits field 436 includes a value indicating the size of the Bits field in a unit (e.g. in a byte), and the Bits field 438 includes a value indicating a corresponding link on the sub-tree. For example, assume that the fields (i.e., L flag field 428, B flag field 432, Link-No field 422, N-Branches field 424 and S-Branches field 426) for the link from P3 to P4 occupy 2 bytes, P field 434 and S-Bits field 436 occupies 1 byte, and the Bits field 438 for the links from P4 occupy 2 bytes. Thus, encoding the branch from P3 uses 5 bytes in total. Therefore, the encoding sub-tree 420 of FIG. 4C can be encoded using fewer bytes relative to the encoding sub-tree 400 of FIG. 4A.

In an embodiment, the number of branches from P4 is the number of bits with value of one in the Bits field. The N-Branches field for the link from P3 to P4 is used for other purposes. In an embodiment, N-Branches field 424 and S-Branches field 426 may be combined to represent the size of the branches plus the fields following.

FIG. 4D is an encoding P2MP tree from an ingress node via transit nodes to another transit nodes and egress nodes using an L flag and a B flag. In the illustrated embodiment, the ingress node is PE1, the next hop nodes are P1, P2, and P3, and the egress nodes are PE8 and PE9.

In an embodiment, the sub-tree from PE1 via P1 towards to P2, P3, PE8, and PE9 in FIG. 1 is represented in FIG. 4D using link numbers and/or link bits. In an embodiment, the encoding sub-tree 430 includes a link number (Link-No) field 442, a number of branches (N-Branches) field 444, and a size of branches (S-Branches) field 446. The Link-No field 442 includes a value indicating the link number of the link from the transmit node to the next hop node along the sub-tree, the N-Branches field 444 (or say sub-trees, links, or next hops) includes a value indicating the number of branches of the next hop node along the sub-tree, and the S-Branches field 446 includes a value indicating a size of the branches of the next hop node along the sub-tree.

Relative to the encoding sub-tree 410 of FIG. 4B, the encoding sub-tree 430 of FIG. 4D is improved by using an L flag in the L flag field 448 and a B flag in a B flag field 450. When set to a particular value (e.g., 1), the B flag in the B flag field 450 indicates that the link bits have been used to represent the link information. The link information may further represent other link related information such as whether next hops are leaves or not. The link bits field contain a plus (P) field 452 (or simply P field), size of the bits (S-Bits) field 454, and a Bits field 456. The S-Bits field 454 includes a value indicating the size of the Bits field in a unit (e.g., in a byte), and the Bits field 456 includes a value indicating a corresponding link on the sub-tree.

For example, B flag in the B flag field 450 for the link from PE1 to P1 is set to one to indicate that the link bits are used to represent the link information from node P1. Assume that the value of P field 452 has a value of 0 (i.e., is set to zero). This indicates that a bit with value of 1 in the Bits field is associated with a corresponding link on the branch and the next hop node is a transit node or leaf node on the tree. As shown in FIG. 1, there are four links from P1, namely a link from P1 to P2, a link from P1 to P3, a link from P1 to PE8, and a link from P1 to PE9. These four links have local link numbers 2, 3, 4, and 5, respectively on P1 and are represented by the 2-th bit, 3-th bit, 4-th bit and 5-th bit in the Bits field 456 (from left to right), respectively. As shown in FIG. 4D, each of these links do not have a Link-No field 442, which is referred to as having reduced fields.

The reduced fields for the link from P1 to P2 (where the L flag field 458 and the B flag field have a value of 0, the N-Branches field 462 has a value of 2, and the S-branches field 464 has a value of 7) indicate that the link's next hop is not a leaf, the link bits are not used for the branches from P2, the number of branches from P2 is two, and a size of branches from P2 along the sub-tree is 7 bytes.

The reduced fields for the link from P1 to P3 (where the L flag field 458 and the B flag field have a value of 0, the N-Branches field 462 has a value of 1, and the S-branches field 464 has a value of 5) indicate that the link's next hop is not leaf, the link bits are not used for the branches from P3, the number of branches from P3 is one, and a size of branches from P3 along the sub-tree is 5 bytes.

The reduced fields for the link from P1 to PE8 (where the L flag field 458 has a value of 1) indicate that the link's next hop node PE8 is a leaf. Because of the value of the L flag in the L flag field 458 is 1, the N-Branches field 462 and S-Branches field 464 have been removed.

The reduced fields for the link from P1 to PE9 (where the Link No field 458 has a value of 1) indicate that the link's next hop node PE9 is a leaf. Because of the value of the L flag in the L flag field 458 is 1, the N-Branches field 462 and S-Branches field 464 have been removed.

For example, assume that the fields (i.e., L flag field 458, B flag field 460, Link-No field 442, N-Branches field 462, and S-Branches field 464) for a link to a transit node occupy 2 bytes, a P field 452 and S-Bits field 454 occupy 1 byte, the reduced fields (i.e., L flag field 458, B flag field 460, N-Branches field 462, and S-Branches field 464) for a link to a transit node occupy 11 bits, the reduced fields (i.e., L flag field 458) for a link to a leaf occupy 1 bit. In this case, the reduced fields for the four links from P1 to P2, P3, PE8, and PE9 use 3 bytes (i.e., 24 bits). Thus, 7 bytes are used to encode the branch part from PE1 via P1 to P2, P3, PE8, and PE9.

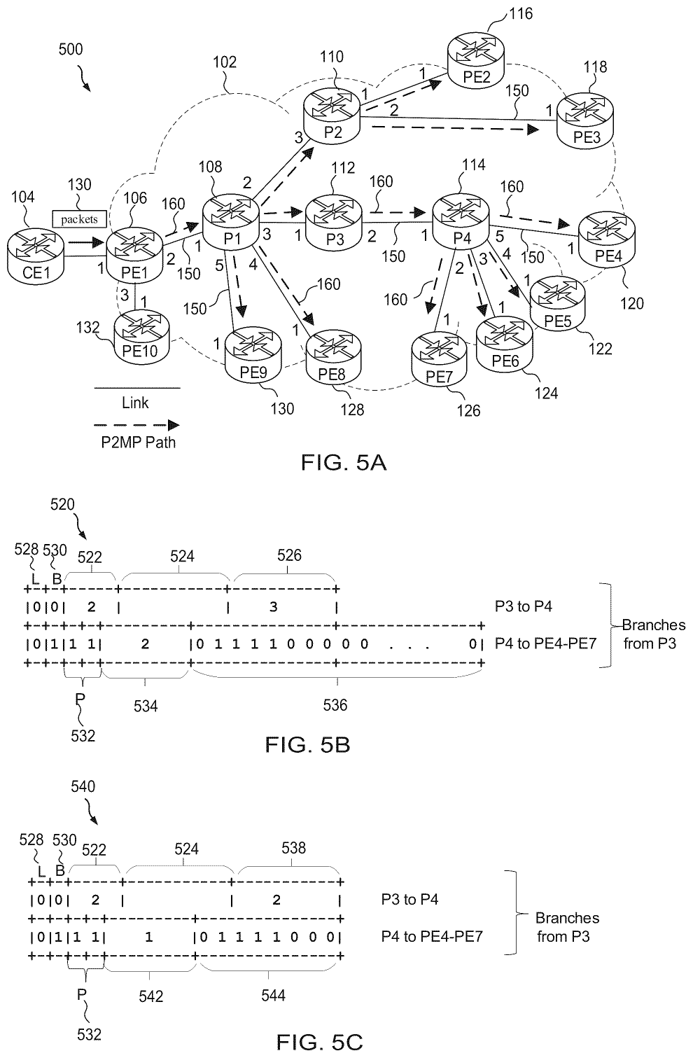

FIG. 5A is a schematic diagram of a network topology 500 including a TE multicast domain 102 along a P2MP path. The network topology 500 is similar to the network topology 100 of FIG. 1. Therefore, a description of like elements is not repeated herein. Unlike the network topology 100 of FIG. 1, the network topology 500 of FIG. 5A includes P4's link bits representing link numbers 2, 3, 4 and 5. As such, link numbers are used when encoding a part of the branches (a.k.a sub-trees/links) from a node is more efficient; otherwise, the link bits are used.

FIG. 5B is an encoding sub-tree from a transit node via another transit node to egress nodes using an L flag and a B flag according to an embodiment of the disclosure.

In an embodiment, the sub-tree from P3 via P4 towards PE4 to PE7 in FIG. 1 is represented in FIG. 5B using link bits. In an embodiment, the encoding sub-tree 520 includes a link number (Link-No) field 522, a number of branches (N-Branches) field 524, and a size of branches (S-Branches) field 526. The Link-No field 522 includes a value indicating the link number of the link from the transmit node to the next hop node along the sub-tree, the N-Branches field 524 (or say sub-trees, links, or next hops) includes a value indicating the number of branches of the next hop node along the sub-tree, and the S-Branches field 526 includes a value indicating a size of the branches of the next hop node along the sub-tree.

Relative to the encoding sub-tree 410 of FIG. 4B, the encoding sub-tree 520 of FIG. 5B is improved by using an L flag in the L flag field 528 and a B flag in a B flag field 530. When set to a particular value (e.g., 1), the B flag in the B flag field 530 indicates that the link bits have been used to represent the link information. The link information may further represent other link related information such as whether next hops are leaves or not. The link bits field contains a plus (P) field 532 (or simply P field), a size of the bits (S-Bits) field 534, and a Bits field 536.

For example, assume that the value of P field 532 for the link from P3 to P4 has a value of 11 (in binary). This indicates that a bit with value of 1 in the Bits field 536 is associated with a corresponding link on the branch and the next hop node is a leaf node. As shown in FIG. 5A, P4 has four links, namely a link from P4 to PE7, a link from P4 to PE6, a link from P4 to PE5, and a link from P4 to PE4. These four links 150 have local link numbers 2, 3, 4, and 5, respectively on P4 and are represented by the 2-nd bit, 3-rd bit, 4-th bit, and 5-th bit in the Bits field 536 (from left to right), respectively.

The S-Bits field 534 includes a value 2 indicating the size of the Bits field in a unit (e.g. in a byte) and the Bits field 536 includes a value indicating a corresponding link on the sub-tree. For example, assume that the fields (i.e., L flag field 528, B flag field 530, Link-No field 522, N-Branches field 524 and S-Branches field 526) for the link from P3 to P4 occupy 2 bytes, P field 532 and S-Bits field 534 occupies 1 byte. Thus, encoding the branch from P3 uses 5 bytes in total. Therefore, the encoding sub-tree 520 of FIG. 5B can be encoded using fewer bytes relative to the encoding sub-tree 410 of FIG. 4B.

In an embodiment, the number of branches from P4 is the number of bits with value of one in the Bits field 536. The N-Branches field 524 for the link from P3 to P4 is used for other purpose. In an embodiment, N-Branches field 524 and S-Branches field 526 may be combined to represent the size of the branches plus the fields following.

FIG. 5C is an encoding sub-tree from a transit node via another transit node to egress nodes using an L flag and a B flag according to an embodiment of the disclosure. The encoding sub-tree 540 is similar to the encoding sub-tree 520 of FIG. 5B. Therefore, a description of like elements is not repeated herein. Unlike the encoding sub-tree 520 of FIG. 5B, the S-Bits field 542 includes a value 1 that indicates the size of the Bits field in a unit (e.g. in a byte) since all the bits (2-nd bit, 3-rd bit, 4-th bit, and 5-th bit in the Bits field 544) with value of one are in the first byte. Thus, only one byte is used to represent the links on the branch from P4. For example, assume that the fields (i.e., L flag field 528, B flag field 530, Link-No field 522, N-Branches field 524 and S-Branches field 538) for the link from P3 to P4 occupy 2 bytes, P field 532 and S-Bits field 542 occupy 1 byte. Thus, encoding the branch from P3 uses 4 bytes in total.

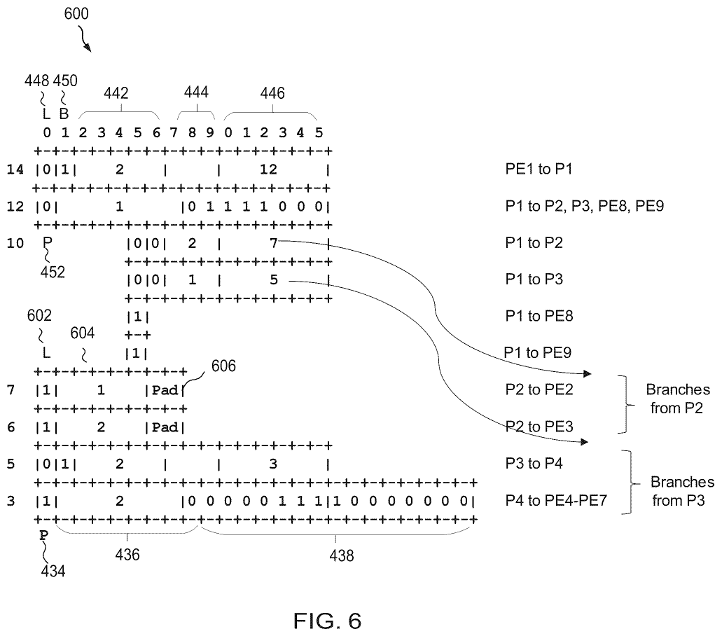

FIG. 6 is an encoding P2MP tree from an ingress node via transit nodes to egress nodes using an L flag and a B flag according to an embodiment of the disclosure. In the illustrated embodiment, the ingress node is PE1, the transit nodes are P1, P2, P3 and P4, and the egress nodes are PE2-PE9. In an embodiment, the sub-tree from PE1 via P1, P2, P3 and P4 towards to PE2-PE9 in FIG. 1 is represented in FIG. 6 using link numbers and link bits. The encoding sub-tree from PE1 via P1 to P2, P3, PE8 and PE9 is similar to the encoding sub-tree 430 of FIG. 4D and occupies 7 bytes.

For the link from P2 to PE2, an L flag field 602 has a value 1 and a Link-No field 604 has a value 1. For the link from P2 to PE3, an L flag field 602 has a value 1 and a Link-No field 604 has a value 2. Thus, the encoding of these two links (P2 to PE2 and P2 to PE3) occupy 2 bytes. In an optional embodiment, when L flag field 602 has a value 1, the Link-No field 604 and a padding field 606 are combined to represent link number.

The encoding sub-tree from P3 via P4 towards PE4-PE7 is similar to the encoding sub-tree 420 of FIG. 4C and occupies 5 bytes. Thus, as shown in FIG. 6, encoding the P2MP tree from an ingress node via transit nodes to egress nodes using an L flag and a B flag using 14 bytes in total. Thus, by using link numbers and link bits, the overhead of encoding the P2MP path/tree is decreased (e.g., the size of the packet header is reduced) and the efficiency of encoding the P2MP path/tree is increased relative to existing techniques.

In a similar way, encoding sub-tree from P3 via P4 towards PE4-PE7 in FIG. 5A is similar to the encoding sub-tree 540 of FIG. 5C and occupies 4 bytes. Thus, encoding the P2MP tree from an ingress node via transit nodes to egress nodes in FIG. 5A using an L flag and a B flag use 13 bytes in total. Thus, by using link numbers and link bits, the overhead of encoding the P2MP path/tree is decreased (e.g., the size of the packet header is reduced) and the efficiency of encoding the P2MP path/tree is increased relative to existing techniques.

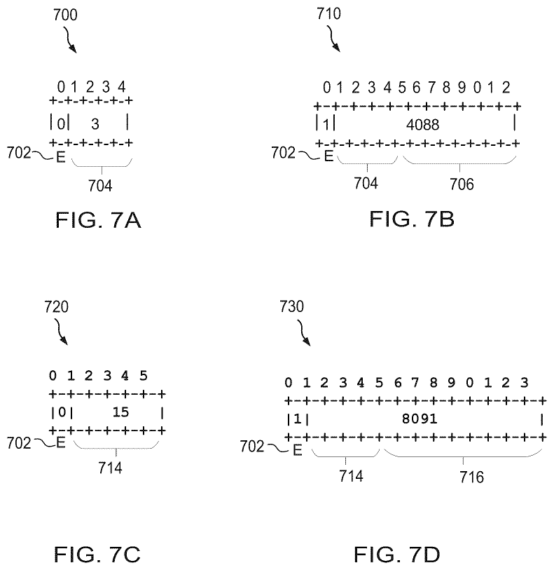

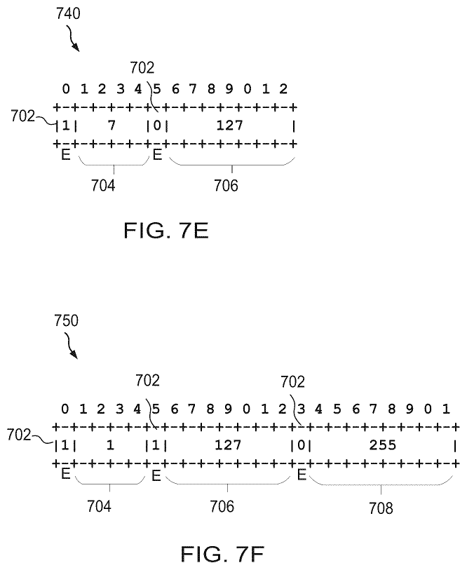

FIG. 7A is a link number (Link-No) field 700 of a link with an E flag set to a first value (e.g., 0) according to an embodiment of the disclosure. As will be explained more fully below, the encoding sub-tree 600 in FIG. 6 may be further improved by adding the E flag into the link number field 700 for a link.

As shown, the link number field 700 includes an E flag field 702 and a basic field 704 corresponding to a link. In an embodiment, the E flag field 702 comprises one bit and the basic field 704 comprises four bits. The E flag field 702 comprises one bit and includes an E flag. The basic field 704 includes a value that represents a particular link.

When the E flag in the E flag field 702 is set to 0, the basic field 704 includes a limited number of bits (e.g., 4 bits) that may be used to represent the link number. For example, assume the link number is 3. This link number can be represented in binary as 0011 using the four available bits. However, when the link number is larger (e.g., 4088), this number cannot be represented in four bits. Indeed, the number 4088 represented in binary is 111111111000, which will not fit within the basic field 704 comprising four bits.

FIG. 7B is a link number field 710 of a link with the E flag set to a second value (e.g., 1) according to an embodiment of the disclosure. To resolve the issue of the link number being too large for the basic field 704 of FIG. 7A, the value of the E flag in the E flag field 702 is set to 1 in FIG. 7B to indicate that the link number field 710 includes both the basic field 704 and an extended field 706. The extended field 706 may be, for example, eight bits. The four bits from the basic field 704 and the eight bits of the extended field 706 provide a combined twelve bits, which is sufficient to include the larger link number 4088 represented in binary as 111111111000.

FIG. 7C is a size of branches (S-Branches) field of a node with an E flag set to a first value (e.g., 0) according to an embodiment of the disclosure. As will be explained more fully below, the encoding sub-tree 600 in FIG. 6 may be further improved by adding the E flag into the S-Branches field 720 for a link.

As shown, the S-Branches field 720 includes an E flag field 702 and a basic field 714 corresponding to a size. In an embodiment, the E flag field 702 comprises one bit and the basic field 714 comprises four bits. The E flag field 702 comprises one bit and includes an E flag. The basic field 714 includes a value that represents a size of branches.

When the E flag in the E flag field 702 is set to 0, the basic field 714 includes a limited number of bits (e.g., 5 bits) that may be used to represent the size of branches. However, when the size is larger (e.g., 8091), this number cannot be represented in five bits. Indeed, the number 8091 will not fit within the basic field 714 comprising five bits.

FIG. 7D is a S-Branches field 730 for a node with an E flag set to a second value (e.g., 1) according to an embodiment of the disclosure. To resolve the issue of the size being too large for the basic field 714 of FIG. 7C, the value of the E flag in the E flag field 702 is set to 1 in FIG. 7D to indicate that the S-Branches field 730 includes both the basic field 714 and an extended field 716. The extended field 716 may be, for example, eight bits. The five bits from the basic field 714 and the eight bits of the extended field 716 provide a combined thirteen bits, which is sufficient to include the larger size 8091.

FIG. 7E is a link number field 740 for a link having the basic field 704 and an extended field 706 according to an embodiment of the disclosure. By way of example, the basic field 704 may be four bits and the extended field 706 may be seven bits. When the link number is too large (e.g., 1023), to be represented by the basic field 704, the value of the E flag in the E flag field 702 is set to 1 to indicate that the link number of the link comprises the basic field 704 and the extended field 706. The four bits from the basic field 704 and the seven bits of the extended field 706 provide a combined eleven bits, which is sufficient to include even larger link numbers. As shown in FIG. 7E, the value of the E flag in the E field 702 in the extended field 706 is set to 0 to indicate that no further extended fields are included in the link number field 740.

FIG. 7F is a link number field 750 for a link having the basic field 704 and first and second extended fields 706, 708 according to an embodiment of the disclosure. By way of example, the basic field 704 may be four bits, the first extended field 706 may be seven bits, and the second extended field 708 may be eight bits. When the link number is too large to be represented by the basic field 704 and the extended field 706 of FIG. 7B, the value of the E flag in the E flag field 702 in the first extended field 706 is set to 1 to indicate that the link number of the link comprises the basic field 704, the first extended field 706, and the second extended field 708. The four bits from the basic field 704, the seven bits of the first extended field 706, and the eight extended bits from the second extended field 708 provide a combined nineteen bits, which is sufficient to include even larger link numbers.

In some embodiments, similar to adding E flag to a Link-No field as discussed above, E flag of E-flag field can also be added into the N-Branches field for a node to represent a larger number of branches.

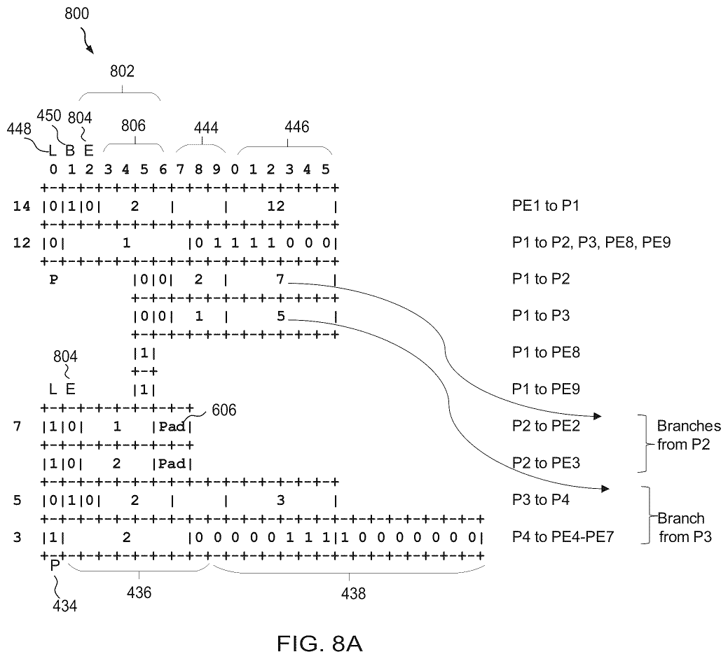

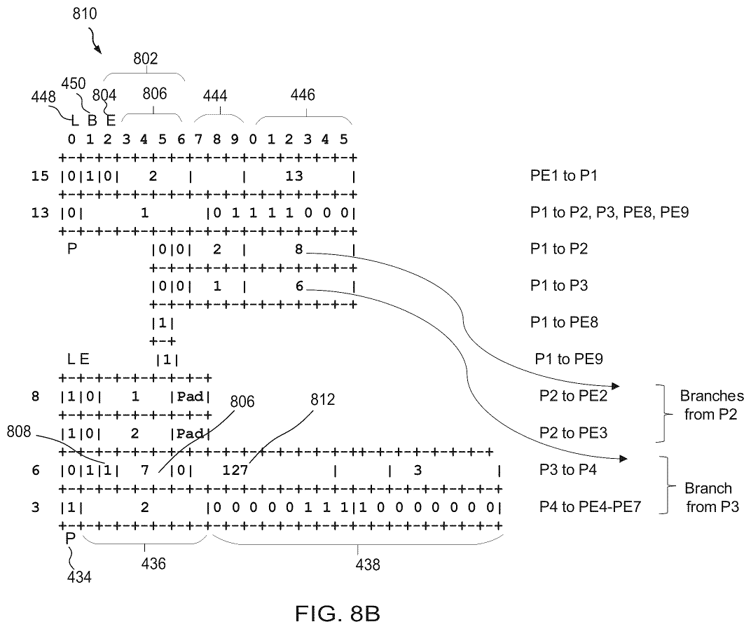

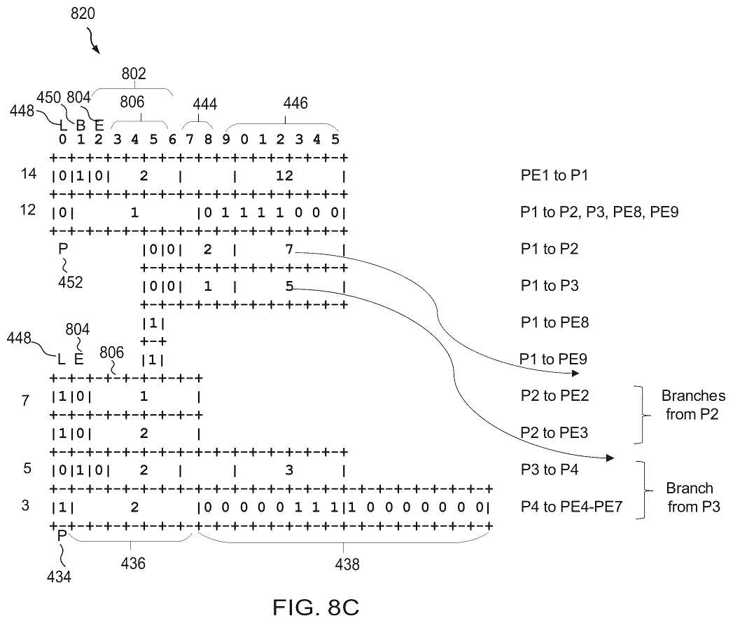

FIG. 8A is an encoding P2MP tree from an ingress node via transit nodes to egress nodes using an L flag, a B flag, and an E flag according to an embodiment of the disclosure. The encoding sub-tree 800 is similar to the encoding sub-tree 600 of FIG. 6. Therefore, a description of like elements is not repeated herein. Unlike the encoding sub-tree 600 of FIG. 6, the encoding sub-tree 800 in FIG. 8A may be further improved by adding the E flag into the link number field 802 for a link along with the L flag in the L flag field 448 and the B flag in B flag field 450. As shown, the link number field 802 includes an E flag field 804 and a basic field 806 corresponding to a link. In an embodiment, the E flag field 804 comprises one bit and the basic field 806 comprises four bits. The E flag field 804 comprises one bit and includes an E flag. The basic field 806 includes a value that represents a particular link.

When the E flag in the E flag field 804 is set to 0, the basic field 806 includes a limited number of bits (e.g., 4 bits) that may be used to represent the link number. For example, assume the link number is 2. This link number can be represented in binary as 0010 using the four available bits. However, when the link number is larger (e.g., 1023), this number cannot be represented in four bits. Indeed, the number 4088, which will not fit within the basic field 806 comprising four bits.

FIG. 8B is an encoding P2MP tree from an ingress node via transit nodes to egress nodes using an L flag, a B flag, and an E flag according to an embodiment of the disclosure. The encoding sub-tree 810 is similar to the encoding sub-tree 800 of FIG. 8A. Therefore, a description of like elements is not repeated herein. Unlike the encoding sub-tree 800 of FIG. 8A, to resolve the issue of the link number being too large for the basic field 806 of FIG. 8A, the value of the E flag in the E flag field 808 is set to 1 in FIG. 8B to indicate that the link number field 802 includes both the basic field 806 and an extended field 812. The extended field 812 may be, for example, eight bits. The four bits from the basic field 806 and the eight bits of the extended field 812 provide a combined twelve bits, which is sufficient to include the larger link number. The S-Branches fields 446 for branches from P3, P2, and P1 are 6, 8 and 13, respectively.

FIG. 8C is an encoding P2MP tree from an ingress node via transit nodes to egress nodes using an L flag, a B flag, and an E flag according to an embodiment of the disclosure. The encoding sub-tree 820 is similar to the encoding sub-tree 800 of FIG. 8A. Therefore, a description of like elements is not repeated herein. Unlike the encoding sub-tree 800 of FIG. 8A, for a link to a leaf node contains an L flag in L flag field 448 of 1 bit and a Link-No field 802 of 7 bits (i.e., the E flag field 804 comprises one bit and the basic field 806 comprises six bits) when the value of the E flag in the E flag field 804 is set to 0. For example, for link from P2 to PE2 (which is a leaf), the link number 1 for the link is stored in the last 6 bits of the byte for storing the information for the link.

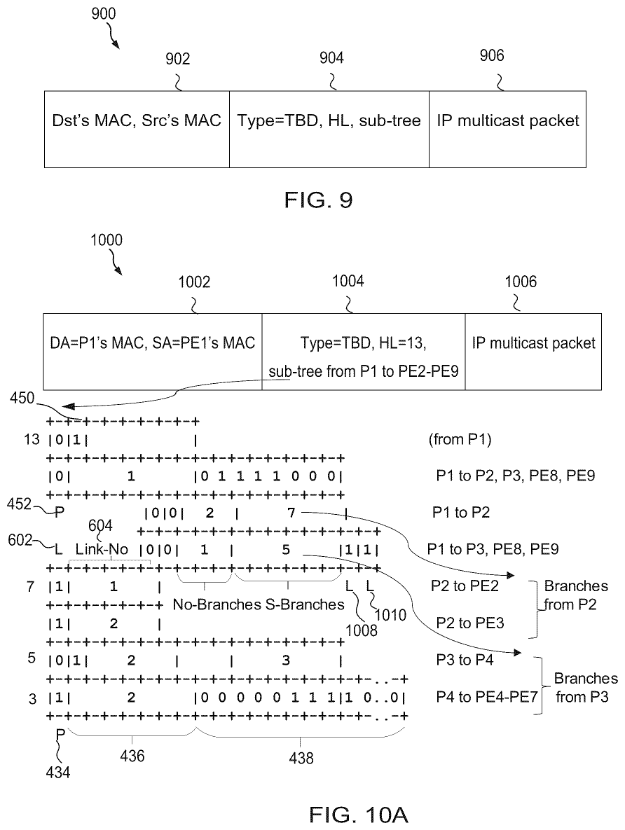

FIG. 9 is an example format of an MRH 904 in a routing packet 900 according to an embodiment of the disclosure. The MRH 904 is layer two and half (L2.5 for short) MRH. Unless stated otherwise, layers discussed herein (e.g., Layer 2, Layer 2.5, or Layer 3) refer to those defined under the International organization of Standardization (ISO) model.

The routing packet 900 comprises a first field 902 including a destination address (DA) and source address (SA) such as destination MAC address and source MAC address, an MRH header 904, and a third field 906 including an IP multicast packet. The MRH header 904 includes a Type field, a header length (HL) field, and a sub-tree field. The Type field is set to a value to indicate that the routing packet is a multicast packet encapsulated in the MRH. The HL field is set to a value to indicate the length of the MRH excluding the Type field and the HL field. The sub-tree field indicates encoding of a sub-tree using link numbers and/or link bits.

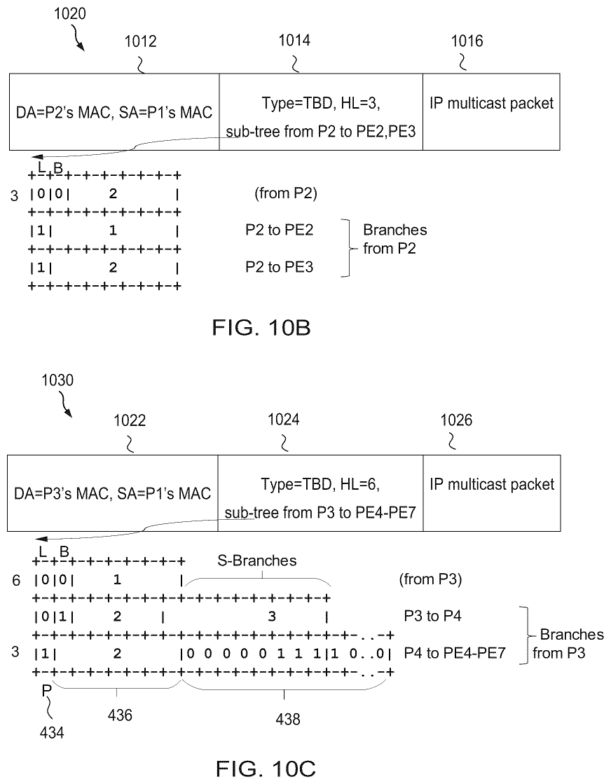

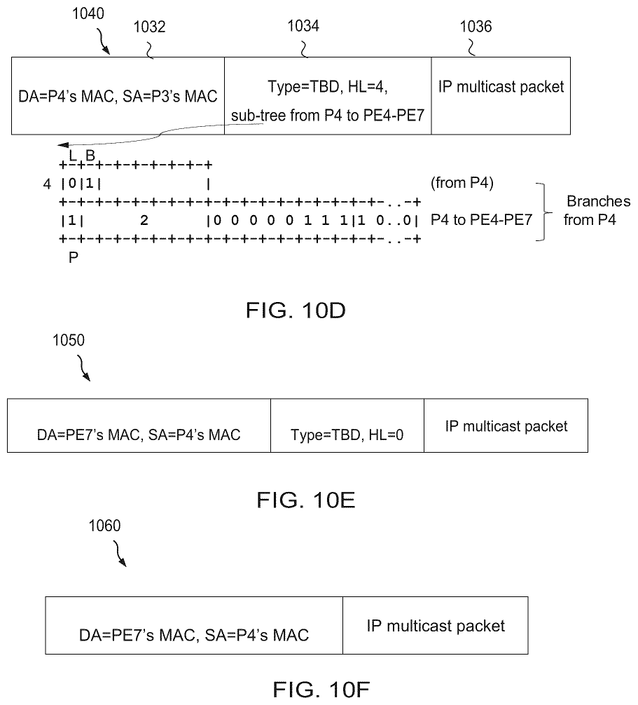

FIG. 10A is an encoding sub-tree from an ingress node via a transit node to egress nodes using an L flag and a B flag, and a multicast routing header (MRH) in a routing packet 1000 according to an embodiment of the disclosure. Reference to the embodiment illustrated in FIG. 5A, the ingress node is PE1, the transit nodes are P1, P2, P3 and P4, and the egress nodes are PE2-PE9. In an embodiment, PE1 builds a MRH based on the encoding of the sub-tree in FIG. 6 through including the information/indication about the number of branches from P1 and the links on the branches from P1 and setting HL to the size of space for storing these (i.e., 1 plus 12, assume that 1 (byte) for storing the information/indication about the number of branches from P1, wherein 12 is the size of branches from P1). The number of branches from P1 is 4, which is the number of bits with value 1 in the Bits field for the links from P1 to P2, P3, PE8 and PE9. This is determined by L=0 and B=1 on the top and the Bits fields pointed by S-Branches (12) for link from PE1 to P1.

For the link from PE1 to P1, B flag in the B flag field 450 for the link from PE1 to P1 is set to one to indicate that the link bits are used to represent the link information from node P1. The value of P field 452 has a value of 0 (i.e., is set to zero) that indicates that a bit with value of 1 in the Bits field means that a corresponding link from downstream node P1 is on the tree/branch. As shown in FIG. 10A, there are four links from P1, namely a link from P1 to P2, a link from P1 to P3, a link from P1 to PE8, and a link from P1 to PE9. These four links have local link numbers 2, 3, 4, and 5, respectively on P1 and are represented by the 2-th bit, 3-th bit, 4-th bit and 5-th bit in the Bits field (from left to right), respectively.

The encoding sub-tree is similar to the encoding sub-tree of FIG. 6. Therefore, a description of like elements is not repeated herein. Unlike the encoding sub-tree 600 of FIG. 6, for an IP multicast packet to be transmitted by the P2MP path/tree, PE1 constructs IP multicast packet for each sub-tree and sends the packet containing the MRH to the next hop node along the sub-tree. The P2MP path/tree has one sub-tree from PE1 via P1 to PE2-PE9. The IP multicast packet may include a first field 1002 setting a DA of the packet to MAC address of P1 and setting SA of the packet to MAC address of PE1, a second header 1004 which is an MRH header, and a third field 1006 including an IP multicast packet. The second header 1004 includes a type field, a header length (HL) field, and a sub-tree field for encoding sub-tree from P1 to PE2-PE9 using link numbers and link bits. The type field includes a value indicating the type of the routing packet or the type of routing header, to indicate that the packet is a multicast packet with MRH or the routing header is an MRH, where the value can be any value that is different from the ones used for other headers and is to be determined (TBD). The header length field including a value set to 13 (i.e., L flag and B flag for the link implying No. of branches from P1 by the number of bits with value 1 in Bits field occupy 1 byte and size of branches from P1 occupy 12 bytes) to indicate the length of the MRH.

For the link from P1 to P2, the 2-th bit with value 1 indicates local link number 2 for the link, and the reduced fields (i.e., L=0, B=0, N-Branches=2, and S-Branches=7) for the link indicate that the link's next hop is not leaf, link bits are not used for the branches from P2, the number of branches from P2 has a value 2 to indicate two branches/links/sub-trees from node P2, and the size of the branches from P2 has a value of 7 to indicate a size of branches from P2 along the sub-tree is 7 bytes.

For the link from P1 to P3, the 3-th bit with value 1 indicates local link number 3 for the link, and the reduced fields (i.e., L=0, B=0, N-Branches=1, and S-Branches=5) for the link indicate that the link's next hop is not leaf, link bits are not used for the branches from P3, the number of branches from P3 has a value 1 to indicate one branch/link/sub-tree from node P3, and the size of the branches from P3 has a value of 5 to indicate a size of branches from P3 along the sub-tree is 5 bytes.

For the link from P1 to PE8, the 4-th bit with value 1 indicates local link number 4 for the link, and the L-field 1008 set to 1 to indicate that the link's next hop is leaf.

For the link from P1 to PE9, the 5-th bit with value 1 indicates local link number 5 for the link, and the L-field 1010 set to 1 to indicate that the link's next hop is leaf.

For the link from P2 to PE2, a Link-No field 604 with the value of 1 indicates the link number of the link.

For the link from P2 to PE3, a Link-No field 604 with the value of 2 indicates the link number of the link.

For the link from P3 to P4, a Link-No field 604 with the value of 2 indicates the link number of the link.

For the link from P4 to PE4-PE7, there are four links from P4, namely a link from P4 to PE4, a link from P4 to PE5, a link from P4 to PE6, and a link from P4 to PE7. These four links have local link numbers 6, 7, 8, and 9, respectively on P1 and are represented by the 6-th bit, 7-th bit, 8-th bit and 9-th bit in the Bits field 438 (from left to right), respectively.

FIG. 10B is an encoding sub-tree from a transit node to egress nodes using an L flag and a B flag, and an MRH in a routing packet 1020 according to an embodiment of the disclosure. The encoding sub-tree is similar to the encoding sub-tree of FIG. 10A. Unlike the encoding sub-tree of FIG. 10A, for a packet to be transported by a P2MP path 160 as shown in FIG. 1, the transit node (e.g., P1) of the P2MP path 160 duplicates the packet for each sub-tree of the P2MP path 160 branching from the transit node. The transit node then sends the packet to the next hop node along the sub-tree as follows.

After receiving the packet from a node (e.g., ingress node PE1), transit node (e.g., P1) determines whether the packet contains the MRH by checking the Type field, the SA, and/or a range of the DA and SA in the packet. When the packet contains the MRH, the transit node duplicates the packet for each branch/sub-tree of the P2MP path 160 branching from the transit node. The transit node then sends a copy of the packet with an updated MRH to the next hop node along the branch/sub-tree.

For example, as shown in FIG. 1, there are four sub-trees branching from P1, namely a first sub-tree from P1 to P2 towards PE2 and PE3, a second sub-tree from P1 to P3 towards PE4 to PE7, a third sub-tree from P1 to PE8, and a fourth sub-tree from P1 to PE9. These four links have local link numbers 2, 3, 4, and 5, respectively on P1.

For the first sub-tree from P1 to P2, P1 duplicates the packet. The duplicated IP multicast packet comprises: a first field 1012 setting a DA of the packet to include MAC address of P2 and setting SA of the packet to include MAC address of P1, a second field 1014 (i.e. an MRH header) including a type field, a header length (HL) field, and a sub-tree field for encoding sub-tree from P2 to PE2, PE9 using link numbers and link bits, and a third field 1016 including an IP multicast packet. In the second field 1014, the type field includes a value indicating the type of the routing packet or the type of routing header, to indicate that the packet is a multicast packet with MRH or the routing header is an MRH. The value can be any value that is different from the ones used for other headers and is to be determined (TBD). The header length field includes a value set to 3 (i.e., No. of branches from P2 occupy 1 byte and size of branches from P2 occupy 2 bytes) to indicate the length of the MRH. P1 then updates the MRH based on the encoding of the sub-tree as shown in FIG. 10B, and sends the packet to next hop along the branch/sub-tree, i.e., P2.

For example, as shown in FIG. 1, there are two sub-trees branching from P2, namely a first sub-tree from P2 to PE2 and a second sub-tree from P2 to PE3. These two links have local link numbers 1 and 2, respectively on P1. The reduced fields indicating a Link-No field and B flag field each have a value of 0. When set to a particular value (e.g., 0), the B flag in the B flag field indicates that the link's next hop is not leaf and link bits is not used for the branches from P2.

After receiving the packet from P1, P2 determines whether the packet contains the MRH. When the packet contains the MRH, P2 duplicates the IP multicast packet for each leaf/egress from P2 to leaves and sends the packet copy to the leaf/egress. P2 sends a copy of IP multicast packet to a first sub-tree PE2 and another copy to a second sub-tree PE3. In one embodiment, P2 sends the copy with MRH containing HL=0 to PE2 and PE3. In another embodiment, P2 sends the copy without MRH to PE2 and PE3.

FIG. 10C is an encoding sub-tree from a node via a transit node to egress nodes using an L flag and a B flag, and a multicast routing header (MRH) in a routing packet 1030 according to an embodiment of the disclosure. The encoding sub-tree is similar to the encoding sub-tree of FIG. 10A. Unlike the encoding sub-tree of FIG. 10A, for a packet to be transported by a P2MP path 160 as shown in FIG. 1, the transit node (e.g., P1) of the P2MP path 160 duplicates the packet for each sub-tree of the P2MP path 160 branching from the transit node. The transit node P1 then sends a copy of the packet to the next hop along the sub-tree as follows.

For the sub-tree from P3, P1 duplicates the packet. The duplicated packet comprises a first field 1022 setting a DA of the packet to include MAC address of P3 and setting SA of the packet to include MAC address of P1. The MAC address of P3 is obtained from the neighbor MAC address table of P1 using the link number 3 from P1 to P3, a second field 1024 (i.e. MRH) including a type field, a header length (HL) field, and a sub-tree field, and a third field 1026 including an IP multicast packet. The type field of the MRH includes a value indicating the type of the routing packet or the type of routing header, to indicate that the packet is a multicast packet with MRH or the routing header is an MRH. The value can be any value that is different from the ones used for other headers and is to be determined (TBD). The header length field includes a value set to 6 (i.e., No. of branches from P3 occupy 1 byte and size of branches from P3 occupy 5 bytes) to indicate the length of the MRH. The sub-tree field is for encoding sub-tree from P3 to PE4-PE7 using link numbers and link bits. P1 then updates the MRH based on the encoding of the sub-tree as shown in FIG. 10A, and sends a copy of the packet with the updated MRH to next hop along the branch/sub-tree, i.e., P2.

For example, as shown in FIG. 1, there is one sub-tree branching from P3, namely a sub-tree from P3 to P4. This link has local link number 2 on P3 and the size of branches from P4 and the ones following them is 3. The reduced fields indicating a Link-No field and a B flag field each have a value of 0.

For example, as shown in FIG. 1, there are four sub-trees branching from P4, namely a first sub-tree from P4 to PE7, a second sub-tree from P4 to PE6, a third sub-tree from P4 to PE5, and a fourth sub-tree from P4 to PE4. These four links 150 have local link numbers 6, 7, 8, and 9, respectively on P4 and are represented by the 6-th bit, 7-th bit, 8-th bit and 9-th bit in the Bits field (from left to right), respectively. When set to a particular value (e.g., 1), the B flag in the B flag field indicates that the link bits have been used to represent the link information. The link information may further represent other link related information such as whether next hops are leaves or not. The link bits field contain a P field, a S-Bits field, and a Bits field.

For example, assume that the value of P field 434 has a value of 1 (i.e., set to one). This indicates that a bit with value of 1 in the Bits field 438 is associated with a corresponding link on the branch and the next hop node is a leaf node. The S-Bits field 436 has a value 2 to indicate the size of the Bits field occupy 2 bytes.

For the link from P4 to PE7, the 6-th bit has value 1 in Bits field indicates link number 6 on P4. For the link from P4 to PE6, the 7-th bit has value 1 in Bits field indicates link number 7 on P4. For the link from P4 to PE5, the 8-th bit has value 1 in Bits field indicates link number 8 on P4. For the link from P4 to PE4, the 9-th bit has value 1 in Bits field indicates link number 9 on P4.

FIG. 10D is an encoding sub-tree from a transit node to egress nodes using an L flag and a B flag, and an MRH in a routing packet 1040 according to an embodiment of the disclosure. The encoding sub-tree is similar to the encoding sub-tree of FIG. 10C. Unlike the encoding sub-tree of FIG. 10C, for the sub-tree from P3 to P4, after receiving the packet from P1, P3 determines whether the packet contains the MRH. When the packet contains the MRH, P3 sends a copy of the packet copy for the branch from P3 to P4.

The duplicated packet comprises a first field 1032 setting a DA of the packet to MAC address of P4 and setting SA of the packet to MAC address of P3. The MAC address of P4 is obtained from the neighbor MAC address table of P3 using the link number 2 from P3 to P4, a second field 1034 (i.e. MRH) including a type field, a header length (HL) field, and a sub-tree field, and a third field 1036 including an IP multicast packet. The type field of the MRH includes a value indicating the type of the routing packet or the type of routing header, to indicate that the packet is a multicast packet with MRH or the routing header is an MRH. The value can be any value that is different from the ones used for other headers and is to be determined (TBD). The header length field includes a value set to 4 (i.e., L flag field and B flag field occupy 1 byte and size of branches from P4 occupy 3 bytes) to indicate the length of the MRH. The sub-tree field is for encoding sub-tree from P4 to PE4-PE7 using link numbers and link bits. P3 updates the MRH based on the encoding of the sub-tree as shown in FIG. 10A, and sends the packet with the updated MRH to next hop node along the branch/sub-tree, i.e., P4.

FIG. 10E is example processing of an MRH in a routing packet 1050 with header length set to a first value according to an embodiment of the disclosure. After receiving the packet from P3, P4 determines whether the packet contains the MRH. P4 duplicates the packet for each leaf/egress from P4 when the packet contains the MRH, and sends the duplicated packet to the leaf/egress PE7, PE6, PE5 and PE4. P4 sends a first copy of IP multicast packet to PE7, a second copy of IP multicast packet to PE6, a third copy of IP multicast packet to PE5, and a fourth copy of IP multicast packet to PE4. In some embodiments, P4 sends a duplicated packet with an updated MRH containing a value of HL set to zero to PE7, PE6, PE5 and PE4. As shown in FIG. 10E, PE7 receives the packet having HL with zero value.

FIG. 10F is example processing of an MRH in a routing packet 1060 without MRH according to an embodiment of the disclosure. In an embodiment, P4 sends a duplicated copy of the packet without MRH to PE7, PE6, PE5 and PE4. As shown in FIG. 10F, PE7 receives the packet without MRH. In some embodiments, when a leaf/egress such as PE7 receives a packet without MRH or with MRH having HL=0, the leaf/egress sends the IP multicast packet to the multicast layer of the leaf/egress.

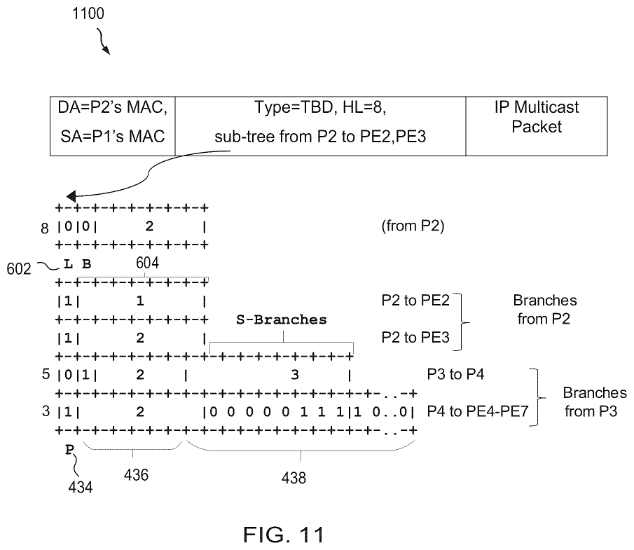

FIG. 11 is an encoding sub-tree from a network node via a transit node to egress nodes using an L flag and a B flag, and an MRH in a routing packet 1100 according to an embodiment of the disclosure. In an embodiment, after a node duplicates the routing packet for a branch/sub-tree from the node, the node updates the MRH in the packet through including the information/indication about the number of branches from the node and the links on the branches/sub-trees from the node and the links following them, and setting HL to the size of space for storing these.

For example, after P1 duplicates the packet for the branch/sub-tree from P1 to P2 towards PE2 and PE3, P1 updates the MRH in the packet based on the sub-tree as in FIG. 10A through including 1) the number of branches from P2, 2) the links on the branch/sub-tree from P2 towards PE2 and PE3, which are the link from P2 to PE2 and the link from P2 to PE3, and 3) the links following them, which are the links from P3 to P4, P4 to PE4-PE7.

P1 then sets the HL to the size of space, and sends the packet with the updated MRH to P2. The HL has set to a value of 8 (i.e., 1 byte plus the value 7 bytes in S-Branches field for the link from P1 to P2 as shown in FIG. 10A).

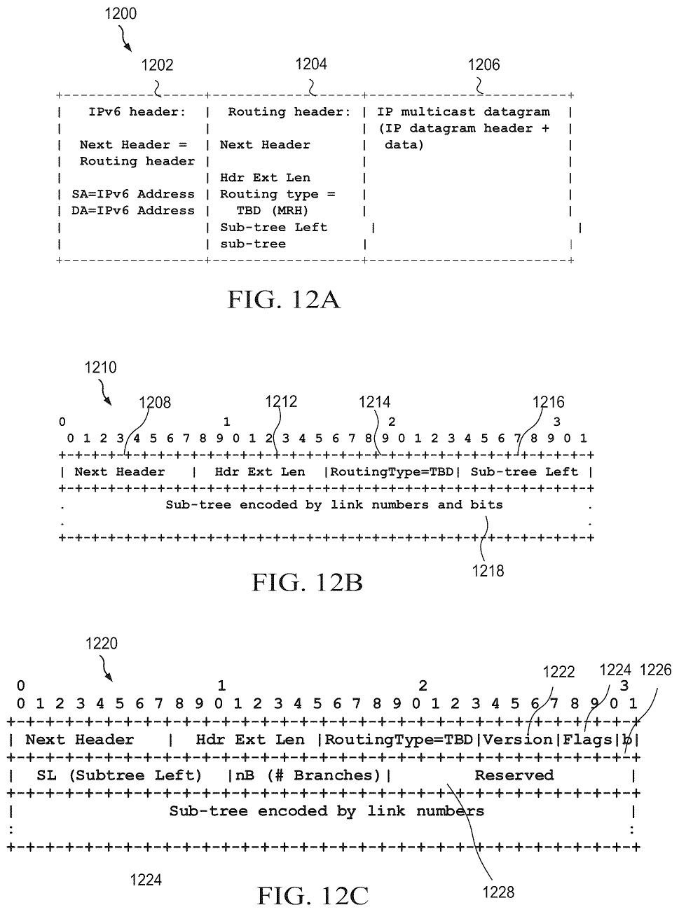

FIG. 12A is an example format of an MRH in a routing packet 1200 according to an embodiment of the disclosure. In this embodiment, the MRH is layer three (L3 for short) MRH in an IPv6 packet. The IPV6 packet comprises an IPV6 header field 1202, a routing header field 1204 (i.e. MRH), and an IP multicast datagram field 1206 including an IP datagram header and data. The IPV6 header field 1202 comprises a destination IPv6 address as DA and source IPV6 address as SA.

FIG. 12B is an example format of an MRH 1210 in a routing packet 1200 according to an embodiment of the disclosure. The MRH 1210 includes a Next Header field 1208, a Hdr Ext Len field 1212, a routing type field 1214, a sub-tree left (SL) field 1216, and a sub-tree field 1218.

The MRH 1210 comprising a Next Header field 1208 with a value indicating the IP multicast datagram header in the packet, a Hdr Ext Len field 1212 with a value indicating the length of the MRH in a unit of 64 bits (i.e., 8 bytes) excluding the first 8 bytes, a Routing type field 1214 with a value (i.e., can be any value that is different from the ones used for other headers and is to be determined (TBD)) indicating that the routing header is an MRH for TE multicast, a Sub-tree Left (SL) field 1216 with a value that acts as a pointer pointing to the sub-tree, and a sub-tree field 1218 indicating encoding the TE multicast sub-tree using link numbers and link bits.

FIG. 12C is an example format of an MRH 1220—in a routing packet with a B flag according to an embodiment of the disclosure. The MRH 1220 is similar to the MRH 1210 of FIG. 12B. Unlike the MRH 1210 of FIG. 12B, the format of the MRH 1220 further includes a version field 1222, a flags field 1224, a b flag field 1226, and a N-Branches (nB) field 1228. The version field 1222 includes a version of the MRH (e.g., version one). The flags field 1224 defines a 1-bit b flag field 1226. The value of b flag field 1226 set to a value (i.e., 1) to indicate the links directly from the root of the sub-tree are encoded by link bits. The N-Branches field 1228 indicating the number of branches from the root of the sub-tree.

In a first case, when the links directly from the root of the sub-tree are encoded by the link numbers of the links, the top is the encoding of the first link of the sub-tree (i.e., the first link from the root of the sub-tree). In a second case, when the links directly from the root of the sub-tree are encoded by link bits, the top is the encoding of the link bits. The b flag field 1226 has set to a first value (i.e., 0) to indicate the first case and N-Branches field 1228 has a value indicating the number of branches/links from the root of the sub-tree in the first case. The b flag field 1226 has set to a second value (i.e., 1) to indicate the second case and N-Branches field 1228 is not used in the second case.

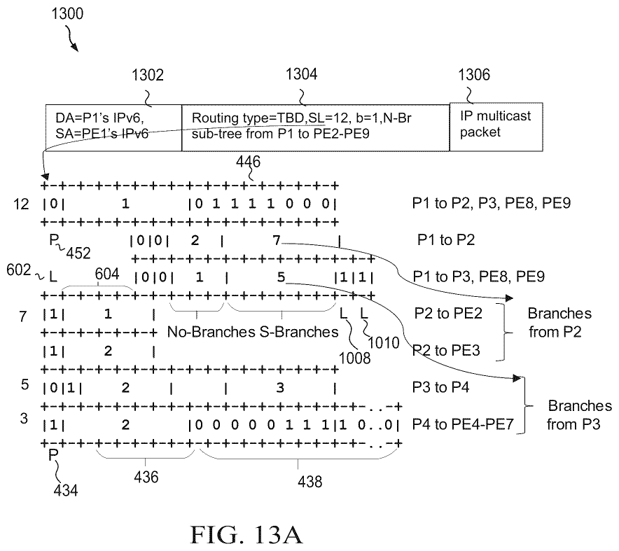

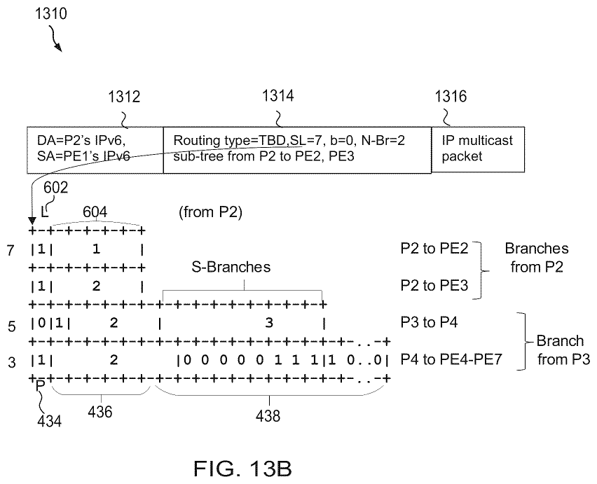

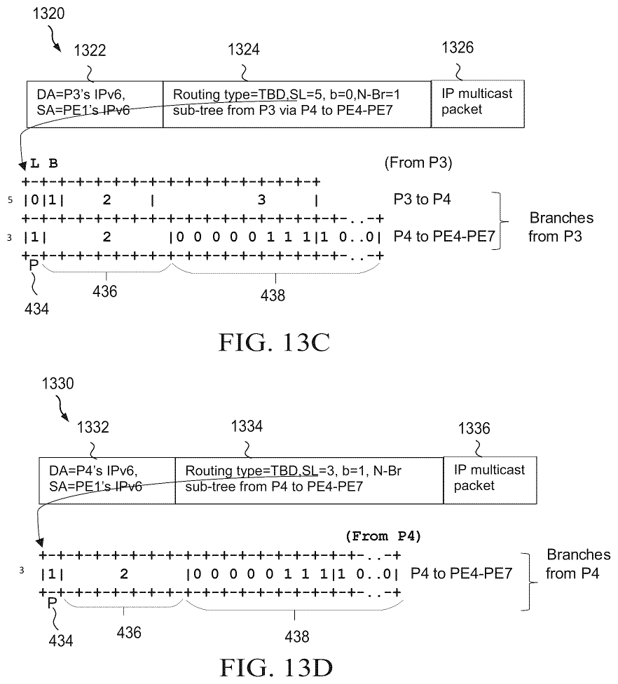

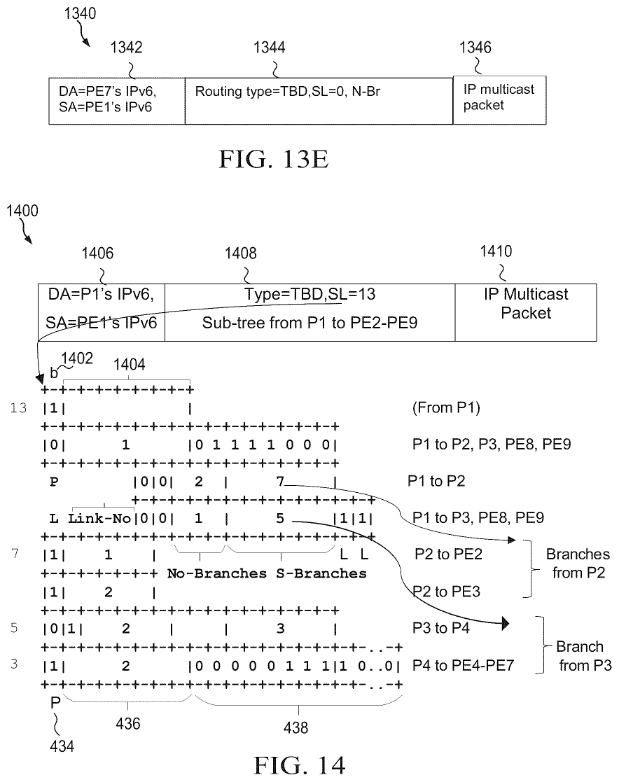

FIG. 13A is an encoding sub-tree from a node via a transit node to egress nodes using an L flag and a B flag, and an MRH in an IPV6 routing packet according to an embodiment of the disclosure. In the illustrated embodiment, the network node is the ingress node PE1, the transit node or next hop node is P1, and the egress nodes are PE2-PE9. In an embodiment, the P2MP path 160 from PE1 via P1 towards PE2-PE9 in FIG. 1 is encoded by the link numbers and/or bits of the links on the tree as represented in FIG. 6.

For the link from PE1 to P1, as shown in FIG. 6, a Link-No field 442 with the value of 2 indicates the link number of the link. The S-Branches field 446 with the value of 12 to indicate a size of branches from P1. B flag in the B flag field 450 for the link from PE1 to P1 is set to one to indicate that the link bits are used to represent the link information from node P1. The value of P field 452 has a value of 0 (i.e., is set to zero) that indicates that a bit with value of 1 in the Bits field is associated with a corresponding link on the branch. As shown in FIG. 13A, there are four links from P1, namely a link from P1 to P2, a link from P1 to P3, a link from P1 to PE8, and a link from P1 to PE9. These four links have local link numbers 2, 3, 4, and 5, respectively on P1 and are represented by the 2-th bit, 3-th bit, 4-th bit and 5-th bit in the Bits field 446 (from left to right), respectively.

The encoding sub-tree is similar to the encoding sub-tree of FIG. 6. Therefore, a description of like elements is not repeated herein. Unlike the encoding sub-tree 600 of FIG. 6, for an IP multicast packet to be transmitted by the P2MP path/tree, PE1 constructs an IPV6 packet for each sub-tree and sends the packet containing the MRH and the IP multicast packet to the next hop node along the sub-tree. The P2MP path/tree has one sub-tree from PE1 via P1 to PE2-PE9. PE1 finds P1's IPV6 address from PE1's neighbor IPV6 address table using the link number 2. The IP multicast packet comprises an IPV6 header field 1302 setting a DA of the IPV6 packet to IPV6 address of P1 and setting SA of the IPV6 packet to IPv6 address of PE1, an MRH field 1304 comprising a Type field, a b flag field, a sub-tree left (SL) field, a Number of Branches (N-Br) field, and a sub-tree field, and an IP multicast datagram field 1306. The Type field includes a value indicating the type of the routing packet. The value can be any value that is different from the ones used for other headers and is to be determined (TBD). The b flag field includes a value (i.e., 1) indicating the links from P1 are encoded by link bits. The sub-tree left (SL) includes a value set to 12 to indicate a value of S-Branches for the link from PE1 to P1, a Number of Branches (N-Br) field indicating the number of branches has not set since B=1, and a sub-tree field for encoding sub-tree from P1 to PE2-PE9 using link numbers and/or link bits.

For the link from P1 to P2, the 2-th bit with value 1 in the Bits field 446 indicates local link number 2 for the link, and the reduced fields (i.e., L=0, B=0, N-Branches=2, and S-Branches=7) for the link indicates that the link's next hop P2 is not leaf, link bits are not used for the branches from P2, the number of branches from P2 has a value 2 to indicate that there are two branches/links/sub-trees from node P2, and the size of the branches from P2 has a value of 7 to indicate that a size of branches from P2 along the sub-tree is 7 bytes.

For the link from P1 to P3, the 3-th bit with value 1 in the Bits field 446 indicating local link number 3 for the link, and the reduced fields (i.e., L=0, B=0, N-Branches=1, and S-Branches=5) for the link indicates that the link's next hop is not leaf, link bits are not used for the branches from P3, the number of branches from P3 has a value 1 to indicate there is one branch/link/sub-tree from node P3, and the size of the branches from P3 has a value of 5 to indicate a size of branches from P3 along the sub-tree is 5 bytes.

For the link from P1 to PE8, the 4-th bit with value 1 in the Bits field 446 indicates local link number 4 for the link, and the L-field set to 1 to indicate for that the link's next hop is leaf.

For the link from P1 to PE9, the 5-th bit with value 1 in the Bits field 446 indicates local link number 5 for the link, and the L-field set to 1 to indicate for that the link's next hop is leaf.

For the link from P2 to PE2, a Link-No field 604 with the value of 1 indicating the link number of the link.

For the link from P2 to PE3, a Link-No field 604 with the value of 2 indicating the link number of the link.

For the link from P3 to P4, a Link-No field 604 with the value of 2 indicating the link number of the link.

For the link from P4 to PE4-PE7, there are four links from P4, namely a link from P4 to PE4, a link from P4 to PE5, a link from P4 to PE6, and a link from P4 to PE7. These four links have local link numbers 6, 7, 8, and 9, respectively on P4 and are represented by the 6-th bit, 7-th bit, 8-th bit and 9-th bit in the Bits field (from left to right), respectively.

FIG. 13B is an encoding sub-tree from a transit node to egress nodes using an L flag and a B flag, a multicast routing header (MRH) in an IPV6 routing packet 1310 according to an embodiment of the disclosure. The encoding sub-tree of FIG. 13B is similar to the encoding sub-tree of FIG. 13A. Unlike the encoding sub-tree of FIG. 13A, for an IPV6 packet to be transported by the P2MP path 160 as shown in FIG. 1, the transit node (e.g., P1) of the P2MP path 160 duplicates the packet for each sub-tree of the P2MP path 160 branching from the transit node. The transit node then sends the packet to the next hop node along the sub-tree as follows.

The encoding sub-tree of FIG. 13B is similar to the encoding sub-tree of FIG. 13A. Therefore, a description of like elements is not repeated herein. Unlike the encoding sub-tree of FIG. 13A, after receiving the IPv6 packet from the ingress node (e.g., PE1), transit node (e.g., P1) determines that the packet's next header is an MRH through checking whether the next header is a routing header and routing type in the routing header is MRH. When the next header is the MRH, P1 duplicates the packet for each link/branch/sub-tree from P1 and sends a copy of the packet with an updated MRH to the next hop along the branch.

As shown in FIG. 13A, since b=1, the number of bits with value 1 in the Bits field 446 pointed by SL=12 is the number of branches/links from P1 (i.e., 4). For the link from P1 to P2, the 2-th bit with value 1 in the Bits field indicating the link with link number 2 for the link. The first reduced fields for link from P1 to P2 indicate the number of branches from P2 is 2, and the size of branches from P2 plus the ones following them is 7.

In one embodiment, as shown in FIG. 13B, P1 duplicates the packet for the link with link number 2, finds P2's IPv6 address from P1's neighbor IPV6 address table using the link number 2 of the link from P1 to P2. The IP multicast packet comprises an IPV6 header field 1312 setting a DA of the IPv6 packet to include IPV6 address of P2, an MRH field 1314 comprising a Type field, a b flag field, a sub-tree left (SL) field, a Number of Branches (N-Br) field, and a sub-tree field, and an IP multicast datagram field 1316. The Type field includes a value indicating the type of the routing packet. The value can be any value that is different from the ones used for other headers and is to be determined (TBD). The b flag field includes a value (i.e., 0) indicating the links from P2 are not encoded by link bits. The sub-tree left (SL) includes a value set to 7 to indicate a value of S-Branches for the link from P1 to P2, a Number of Branches (N-Br) field indicating the number of branches set to value 2, and a sub-tree field for encoding sub-tree from P2 to PE2 and PE3 using link numbers and/or link bits. As such, P1 updates the MRH by setting SL, b, and N-Br to S-Branches=7, B=0, and N-Branches=2 for the link from P1 to P2, respectively, and sends the packet to next hop along the branch/sub-tree, i.e., P2 as shown in FIG. 13B.

For example, as shown in FIG. 1, there are two sub-trees branching from P2, namely a first sub-tree from P2 to PE2 and a second sub-tree from P2 to PE3. These two links have local link numbers 1 and 2, respectively on P1. The reduced fields indicating a Link-No field and a B flag field each have a value of 0. When set to a particular value (e.g., 0), the B flag in the B flag field indicates that the link's next hop is not leaf and link bits is not used for the branches from P2. PE2 and PE3 are leaves (i.e., egresses), which are indicated by L=1.

In one embodiment, the fields for encoding the branch from P3 follows the branches from P2.

The 3-th bit with value 1 indicates the link with link number 3, which is the link from P1 to P3. The second reduced fields are for link from P1 to P2 and indicates the number of branches from P3 is 1 and the size of branches from P3 plus the ones following them is 5.

For the link from P1 to P3, P1 duplicates the packet for the link with link number 3 and sends a copy of the packet with an updated MRH to P3.

For the link from P1 to PE8, the 4-th bit with value 1 indicates local link number 4 for the link, and the L field 1008 set to 1 to indicate for that the link's next hop is leaf

P1 duplicates the packet for the link with link number 4 and sends a copy of the packet with an updated MRH to PE8.

For the link from P1 to PE9, the 5-th bit with value 1 indicates local link number 5 for the link, and the L field 1010 set to 1 to indicate for that the link's next hop is leaf.

P1 duplicates the packet for the link with link number 5 and sends a copy of the packet with an updated MRH to PE9.

FIG. 13C is an encoding sub-tree from a transit node to egress nodes using an L flag and a B flag, a multicast routing header (MRH) in an IPV6 routing packet 1320 according to an embodiment of the disclosure. The encoding sub-tree of FIG. 13C is similar to the encoding sub-tree of FIG. 13A. Unlike the encoding sub-tree of FIG. 13A, for a packet to be transported by a P2MP path 160 as shown in FIG. 1, the transit node (e.g., P1) of the P2MP path 160 duplicates the packet for each sub-tree of the P2MP path 160 branching from the transit node. The transit node then sends the packet to the next hop along the sub-tree as follows.

P1 duplicates the packet for the link with link number 3 (which is link from P1 to P3), finds P3's IPV6 address from P1's neighbor IPV6 address table using the link number 3 of the link from P1 to P3. The IP multicast packet comprises an IPV6 header field 1322 setting a DA of the IPV6 packet to IPv6 address of P3, an MRH field 1324 comprising a Type field, a b flag field, a sub-tree left (SL) field, a Number of Branches (N-Br) field, and a sub-tree field, and an IP multicast datagram field 1326. The Type field includes a value indicating the type of the routing packet. The value can be any value that is different from the ones used for other headers and is to be determined (TBD). The b flag field includes a value (i.e., 0) indicating the links from P3 are not encoded by link bits. The sub-tree left (SL) includes a value set to 5 indicates value of S-Branches for the link from P1 to P3, a Number of Branches (N-Br) field indicating the number of branches set to value 1, and a sub-tree field for encoding sub-tree from P3 via P4 to PE4-PE7 using link bits. As such, P1 updates the MRH by setting SL, b, and N-Br to S-Branches=5, B=0, and N-Branches=1 for the link from P1 to P3. respectively and sends the packet to next hop along the branch/sub-tree, i.e., P3 as shown in FIG. 13C.

The number of branches from P3 is 1. The link number of the link from P3 to P4 is 2 on P3. The size of branches from P4 is 3. B=1 for the link from P3 to P4 indicates that the links from P4 are encoded by link bits. The number of branches from P4 is the number of bits with value 1 in the Bits field for the links from P4 to PE4-PE7.

FIG. 13D is an encoding sub-tree from a transit node to egress nodes using an L flag and a B flag, and an MRH in an IPV6 routing packet 1330 according to an embodiment of the disclosure. The encoding sub-tree of FIG. 13D is similar to the encoding sub-tree of FIG. 10C. Unlike the encoding sub-tree of FIG. 10C, after receiving the IPV6 packet from P1, P3 determines whether the packet's next header is an MRH. When the packet's next header is the MRH, P3 duplicates the packet for each link/branch/sub-tree from P3 and sends the packet copy with an updated MRH to the next hop node along the branch. There is one branch from P3 according to the sub-tree remaining in the MRH in the packet received by P3. The branch/subtree is from the link from P3 to P4 towards PE4-PE7.

P3 duplicates the packet for the branch/sub-tree, finds P4's IPV6 address from P3's neighbor IPv6 address table using the link number 2 of the link from P3 to P4. The IP multicast packet comprises an IPV6 header field 1332 setting a DA of the IPV6 packet to IPv6 address of P4, an MRH field 1334 comprising a Type field, a b flag field, a sub-tree left (SL) field, a Number of Branches (N-Br) field, and a sub-tree field, and an IP multicast datagram field 1336. The Type field includes a value indicating the type of the routing packet. The value can be any value that is different from the ones used for other headers and is to be determined (TBD). The b flag field includes a value (i.e., 1) indicating the links from P4 are encoded by link bits. The sub-tree left (SL) includes a value set to 3 indicates a value of S-Branches for the link from P3 to P4, a Number of Branches (N-Br) field indicating the number of branches set to value 1, and a sub-tree field for encoding sub-tree from P4 to PE4-PE7 using link bits. As such, P3 updates the MRH by setting SL, b, and SL to S-Branches=3, B=1, and N-Branches is not set or used since b=1, respectively and sends the packet to next hop node along the branch/sub-tree, i.e., P4 as shown in FIG. 13D.

After receiving the layer 3 packet from P3, P4 determines whether the packet's next header is an MRH. When the packet's next header is the MRH, P4 duplicates the packet for each branch/link from P4 and sends the packet copy with an updated MRH to the next hop node along the branch. There are 4 branches/links from P4 according to the sub-tree remaining in the MRH in the packet received by P4.

The 6-th bit with value 1 in the Bits field indicates the link with link number 6, which is the link from P4 to leaf PE7.

The 7-th bit with value 1 in the Bits field indicates the link with link number 7, which is the link from P4 to leaf PE6.

The 8-th bit with value 1 in the Bits field indicates the link with link number 8, which is the link from P4 to leaf PE5.

The 9-th bit with value 1 in the Bits field indicates the link with link number 9, which is the link from P4 to leaf PE4.

FIG. 13E is example an IPv6 routing packet 1340 including a routing header 1344 with segment length set to a first value according to an embodiment of the disclosure. As discussed in FIG. 10D, after receiving the packet from P3, P4 determines whether the packet's next header is an MRH. When the packet's next header is the MRH, P4 duplicates the packet for each branch/link from P4 and sends the packet copy with an updated MRH to the next hop along the branch. There are 4 branches/links from P4 according to the sub-tree remaining in the MRH in the packet received by P4.

In an embodiment, P4 duplicates the packet for the first link and finds PE7's IPV6 address from P4's neighbor IPV6 address table using the link number 6 of the link from P4 to PE7. The IP multicast packet 1340 comprises an IPV6 header field 1342 setting a DA of the IPV6 packet to IPv6 address of PE7, an MRH field 1344 comprising a Type field, a b flag field, a sub-tree left (SL) field, a Number of Branches (N-Br) field, and a sub-tree field, and an IP multicast datagram field 1346. The Type field includes a value indicating the type of the routing packet. The value is can be any value that is different from the ones used for other headers and to be determined (TBD). The sub-tree left (SL) includes a value set to zero. As such, P4 updates the MRH, and sends the packet to each of PE6, PE5 and PE4 as shown in FIG. 13E.

After receiving the packet from P4, PE7 determines whether the packet's next header is an MRH. When the packet's next header is the MRH, PE7 checks whether PE7 itself is a leaf (i.e., egress) through checking whether SL is 0. When PE7 is a leaf, PE7 decapsulates the packet and sends the IP multicast datagram to the IP multicast forwarding module.

Alternatively, after receiving the packet from P3 and determining that the packet's next header is an MRH, P4 checks whether each of its next hops is a leaf. When the next hop node is a leaf, P4 decapsulates the packet and sends the IP multicast datagram to the next hop node. Since next hops PE4-PE7 are leaves, P4 sends the IP multicast datagram to PE4-PE7.

In another embodiment, P4 decapsulates the packet and sends the IP multicast datagram to the next hop node (i.e., the leaf) of each link. P4 duplicates the packet for the first link without MRH, finds PE7's IPV6 address from P4's neighbor IPv6 address table using the link number 6 of the link from P4 to PE7, sets DA of the packet to PE7's IPV6 address and SA of the packet to P4's IPv6 address, and sends the packet copy without MRH to PE7.

FIG. 14 is an encoding sub-tree from an ingress node via a transit node to egress nodes using an L flag and a B flag, and an MRH in a routing packet 1400 according to an embodiment of the disclosure. The encoding sub-tree of FIG. 14 is similar to the encoding sub-tree of FIG. 13A. In one embodiment, unlike the encoding sub-tree of FIG. 13A, the b flag field 1402 and N-Branches field 1404 has placed above the fields for encoding the links from the root (i.e., P1) of the sub-tree. For an IP multicast packet to be transmitted by the P2MP path/tree, PE1 constructs IPv6 packet for each sub-tree/branch and sends the IPV6 packet containing an MRH and the IP multicast packet to the next hop along the sub-tree. The P2MP path/tree has one sub-tree from PE1 via P1 to PE2-PE9. PE1 finds P1's IPV6 address from PE1's neighbor IPV6 address table using the link number 2 of the link from PE1 to P1.

The IP multicast packet 1400 comprises an IPV6 header field 1406 setting a DA of the IPv6 packet to IPv6 address of P1 and setting SA of the IPV6 packet to IPv6 address of PE1, an MRH field 1408 comprising a Type field, a sub-tree left (SL) field, and a sub-tree field, and an IP multicast datagram field 1410. The Type field includes a value indicating the type of the routing packet. The value can be any value that is different from the ones used for other headers and is to be determined (TBD). The sub-tree left (SL) includes a value set to 13. As such, PE1 updates the MRH, and sends the packet to P1 as shown in FIG. 14. PE1 builds the MRH by setting b field to one since the links from P1 are encoded by link bits and setting SL to 13, and sends the IPV6 packet to P1.

In another embodiment, the b flag field and the N-Branches field are in a fixed location, which follows the SL field. The value in SL field acts as a pointer pointing to the top of the sub-tree remaining (i.e., the fields encoding the links/branches from the root of the sub-tree). In fact, the whole sub-tree from PE1 is not changed, only SL, b field, and N-Branches field are changed when a copy of the IPV6 packet has sent along the sub-tree.

In another embodiment, the b field and the N-Branches field are not in a fixed location. The location is pointed by SL. The value in SL field acts as a pointer pointing the location of b field and N-Branches field, which is followed by the sub-tree remaining (i.e., the fields encoding the links/branches from the root of the sub-tree). Thus, the parts of the sub-tree from PE1 are changed with updates to the b field and the N-Branches field when a copy of the IPV6 packet has sent along the sub-tree.

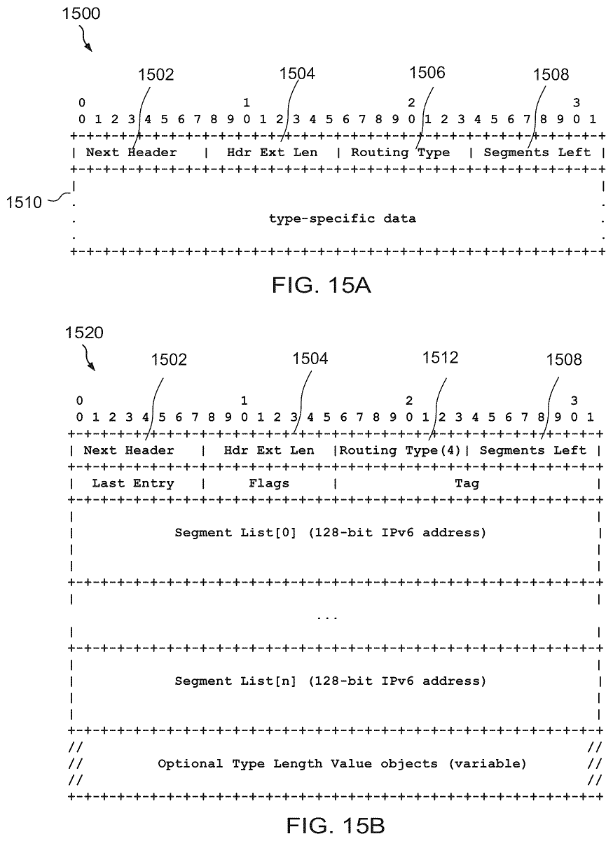

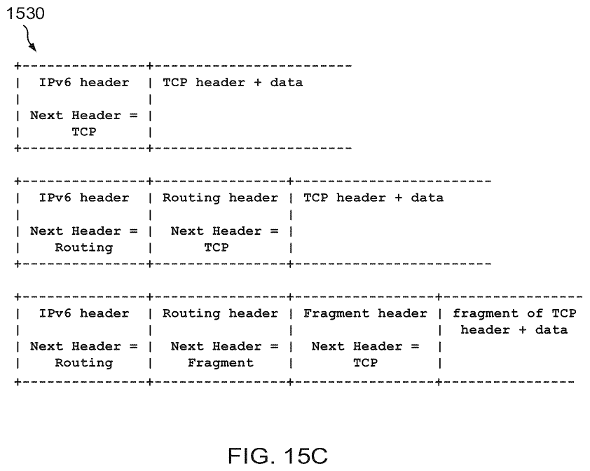

FIG. 15A is an example format of a routing header 1500 (or segment routing header (SRH) in a routing packet according to an embodiment of the disclosure. The routing header 1500 comprises a next header field 1502 (i.e., 8 bit selector) identifying a type of header immediately following the routing header, a Hdr Ext Len field 1504 (i.e., 8-bit unsigned integer) indicating length of the routing header in 8-octet units, a routing type field 1506 (i.e., 8-bit identifier) indicting a particular routing header variant, a segments left field 1508 (i.e., 8-bit unsigned integer) indicating number of route segments remaining (i.e., number of explicitly listed intermediate nodes still to be visited before reaching the final destination), and a type-specific data field 1510 indicating a variable-length field, of format determined by the routing type, and of length such that the complete routing header is an integer multiple of 8 octets long. The SRH of FIG. 15A is described in further detail in Internet Engineering Task Force (IETF) document Request for Comments (RFC) 8200 entitled “Internet Protocol, Version 6 (IPv6) Specification” by S. Deering et al., published July 2017.

FIG. 15B is an example format of a segment routing header (SRH) 1520 in a routing packet according to an embodiment of the disclosure. The format of the SRH 1520 is similar to the format of the SRH 1500 of FIG. 15A. Therefore, a description of like elements is not repeated herein. Unlike the SRH 1500 of FIG. 15A, the SRH 1520 comprises a new Routing Type (4) field 1512 in the routing header. The SRH of FIG. 15B is described in further detail in IETF document RFC 8754 entitled “IPv6 Segment Routing Header (SRH)” by C. Filsfils, Ed. et al., published March 2020.

FIG. 15C is an example format of an Internet Protocol (IP) header in a routing packet 1530 according to an embodiment of the disclosure. In IPV6, optional internet-layer information is encoded in separate headers that may be placed between the IPv6 header and the upper layer header in a packet. Such extension headers may be identified by a distinct Next Header value. Extension headers are numbered from Internet Assigned Numbers Authority (IANA) IP Protocol numbers, the same values used for IPV4 and IPV6. When processing a sequence of Next Header values in a packet, the first one that is not an extension header indicates that the next item in the packet is the corresponding upper-layer header. A special “No Next Header” value is used when there is no upper-layer header. As Shown in FIG. 15C, an IPv6 packet may carry zero, one, or more extension headers, each identified by the Next Header field of the preceding header. Extension headers (except for the Hop-by-Hop Options header) are not processed, inserted, or deleted by any node along a packet's delivery path, until the packet reaches the node (or each of the set of nodes, in the case of multicast) identified in the destination Address field of the IPV6 header.

In one embodiment, at the destination node, normal demultiplexing on the Next Header field of the IPV6 header invokes the module to process the first extension header, or the upper-layer header if no extension header is present. The contents and semantics of each extension header determine whether or not to proceed to the next header.

The procedure or behavior on an ingress node (PE1) of a P2MP path is discussed.

For a packet to be transported by a P2MP path 160 as shown in FIG. 1, the ingress node (e.g., PE1) of the P2MP path 160 duplicates the packet for each sub-tree of the P2MP path 160 branching from the ingress node and encapsulates the packet copy in an MRH containing the sub-tree. The ingress node then sends the packet to the next hop along the sub-tree. For example, there is one sub-tree branching from the ingress of the P2MP path/tree as in FIG. 1. The sub-tree is from ingress PE1 via next hop node P1 towards PE2 to PE9. In a first embodiment, ingress node PE1 sends the packet to P1 as illustrated in FIG. 10A. In a second embodiment, ingress node PE1 sends the packet to P1 as illustrated in FIG. 13A.

The procedure or behavior on a transit node of a P2MP path is discussed.

When a transit node of a P2MP path/tree receives a packet transported by the P2MP path, the transit node determines whether the current routing header is an MRH. After determining that the routing header is an MRH, the node executes the procedure to duplicate the packet for each of the downstream links of the node on the P2MP path/tree and send a copy of the packet to next hop (i.e., downstream node) of the link.

Suppose that the transit node receives the packet from an upstream link from an upstream node to the transit node and there are n downstream links from the transit node on the P2MP path/tree (i.e., there are n branches/sub-trees from the transit node on the P2MP path/tree, where n is greater than zero).

The information about the upstream link is in a b flag field and a N-Br field of the MRH. When b=0, the N-Br field contains the number of branches from the transit node. The information about n downstream links is pointed by SL. When b=1, the number of branches from the transit node is the number of bits with value 1 in the Bits field of the Bits fields pointed by SL. The information about n downstream links is encoded by the Bits field and the fields following the Bits field.

For example, when node P1 receives the packet transported by the P2MP path/tree in FIG. 1 from ingress PE1, the MRH is illustrated in FIG. 13A. The b=1, the Bits field of the Bits fields pointed by SL=12 has 4 bits with value 1. As such, there are 4 branches from P1. The information about 4 downstream links (i.e., link from P1 to P2, link from P1 to P3, link from P1 to PE8 and link from P1 to PE9) is encoded by the Bits field and the reduced fields for these 4 links following the Bits field.

The top of the MRH (i.e., the root (information) of the sub-trees) is indicated by SL. For example, when P1 receives the packet transported by the P2MP path/tree in FIG. 1 from PE1, the MRH is illustrated in FIG. 13A. SL in the MRH is 12 (bytes), which acts as a pointer pointing to the root (information) of the sub-trees from P1. The root (information) is the information about the links from P1.

For each of the downstream links of the transit node, the transit node duplicates the packet for the link, sets SL, b flag field, and N-Br field in the copy of the packet accordingly. When the next hop is a leaf (i.e., egress), the transit node sets SL to 0; otherwise, the transit node sets SL, b flag field, and N-Br field to the value of S-Branches, B, and N-Branches for the link, respectively when B is 0. When B=1, the transit node sets SL and b to the value of S-Branches and B for the link, respectively. The transit node finds the IPV6 address of the next hop (i.e., the downstream node) of the link from the neighbor IPV6 address table of the transit node using the link number of the link, sets the DA of the packet copy to the IPV6 address of the next hop, and sends the packet copy to the next hop of the link.

For example, for the first downstream link from P1 (i.e., link from P1 to P2), P1 duplicates the packet for the link, sets SL to 7 (which is the value of the S-Branches field for the link), b to 0 (which is the value of B for the link) and N-Br field to 2 (which is the value of the N-Branches field for the link). P1 finds the IPV6 address of the next hop node P2 of the link from the neighbor IPv6 address table of P1 using the link number 2 of the link, sets the DA of the packet copy to the P2's IPV6 address, and sends the packet copy to P2. The packet copy received by P2 is shown in FIG. 13B.

For the second downstream link from P1 (i.e., link from P1 to P3), P1 duplicates the packet for the link, sets SL, b flag field, and N-Br field to 5, 0, and 1, respectively, which are the values of S-Branches, B, and N-Branches for the link from P1 to P3, respectively. P1 finds the IPV6 address of the next hop node P3 of the link from the neighbor IPv6 address table of P1 using the link number 3 of the link, sets the DA of the packet copy to the P3's IPV6 address, and sends the packet copy to P3. The packet copy received by P3 is illustrated in FIG. 13C.

For the 3-th downstream link from P1 (i.e., link from P1 to PE8), P1 duplicates the packet for the link, sets SL to 0 since PE8 is a leaf (i.e., egress). P1 finds the IPV6 address of the next hop node PE8 of the link from the neighbor IPV6 address table of P1 using the link number 4 of the link, sets the DA of the packet copy to the PE8's IPV6 address, and sends the packet copy to PE8.

In another embodiment, when a transit node of a P2MP path/tree receives a packet transported by the P2MP path/tree, the packet is encapsulated with an MRH. The node determines whether the MRH is a L2.5 MRH. After determining that the MRH is a L2.5 MRH, the node executes the procedure to duplicate the packet for each of the downstream links of the node on the P2MP path/tree and send the packet copy to the next hop node (i.e., downstream node) of the link.

Suppose that the transit node receives the packet from an upstream link from an upstream node to the transit node and there are n downstream links from the transit node on the P2MP path/tree (i.e., there are n branches/sub-trees from the transit node on the P2MP path/tree, wherein n is greater than zero).

The number of branches/sub-trees from the transit node is on the top of the L2.5 MRH. When B=0, N-Branches field for the upstream link contains the number of branches from the transit node. The information about n downstream links follows the information about the number of branches/sub-trees.

When B=1, the number of branches from the transit node is the number of bits with value 1 in the Bits field of the Bits fields pointed by the value of S-Branches field for the upstream link, which is the value of HL minus 1. The information about n downstream links is encoded by the Bits field and the reduced fields for these n downstream links following the Bits field.

For example, when node P1 receives the packet transported by the P2MP path/tree in FIG. 1 from ingress PE1, the L2.5 MRH is illustrated in FIG. 10A. On the top of the L2.5 MRH, B=1, the number of branches/sub-trees from P1 is the number of bits with value 1 in the Bits field of the Bits fields pointed by (HL-1)=12 as a pointer. The Bits field has 4 bits with value 1. There are 4 links/branches from P1. The information about these 4 downstream links from P1 is encoded by the Bits field and the reduced fields for these 4 links following the Bits field.

The top of the L2.5 MRH is indicated by HL. For example, when P1 receives the packet transported by the P2MP path/tree in FIG. 1 from PE1, the L2.5 MRH is illustrated in FIG. 10A. HL in the L2.5 MRH is 13 (bytes), which acts as a pointer pointing to the root (information) of the sub-trees from P1. The root (information) is the information about the number of branches/sub-trees from P1.

For each of the downstream links of the transit node, the transit node duplicates the packet for the link, sets HL in the packet copy to the size of the space/memory for storing the sub-trees from the next hop node of the link, makes the L2.5 MRH contain the information about the sub-trees from the next hop node (i.e., the number of branches/sub-trees from the next hop node and the information about the links on the sub-trees), finds the MAC address of the next hop node (i.e., the downstream node) of the link from the neighbor MAC address table of the transit node using the link number of the link, sets the DA of the packet copy to the MAC address of the next hop node, sets the SA of the packet copy to the MAC address of the transit node, and sends the packet copy to the next hop node of the link.

For the first downstream link with S-Branches field, HL is set to the value of the S-Branches field for the first downstream link minus the value of the S-Branches field for the second downstream link with S-Branches field plus the size of the space/memory for storing the number of branches from the next hop node (i.e., the downstream node) of the first downstream link. The information about the links on the sub-trees from the next hop node is in the area indicated by the value of the S-Branches field for the first downstream link as a starting point and the value of the S-Branches field for the second downstream link plus 1 as an ending point.

For the i-th downstream link (i<n) with S-Branches field, HL is set to the value of the S-Branches field for the i-th downstream link minus the value of the S-Branches field for the (i+1)-th downstream link with S-Branches field plus the size of the space/memory for storing the number of branches from the next hop node (i.e., the downstream node) of the i-th downstream link. The information about the links on the sub-trees from the next hop node is in the area indicated by the value of the S-Branches field for the i-th downstream link as a starting point and the value of the S-Branches field for the (i+1)-th downstream link plus 1 as an ending point.

For the i-th downstream link (i=n) with S-Branches field, HL is set to the value of the S-Branches field for the i-th downstream link plus the size of the space/memory for storing the number of branches from the next hop node (i.e., the downstream node) of the i-th downstream link. The information about the links on the sub-trees from the next hop node is in the area indicated by the value of the S-Branches field for the i-th downstream link as a starting point and 1 as an ending point.

For example, for the first downstream link from P1 (i.e., link from P1 to P2), P1 duplicates the packet for the link, sets HL to 3 (which is the value 7 of the S-Branches field for the link from P1 to P2 minus the value 5 of the S-Branches field for the link from P1 to P3, plus 1, where 1 (byte) is the size of the space/memory for storing the number of branches from P2). The information about the links on the sub-trees/branches from next hop node P2 is in the area from 7 to 5 (i.e., from byte 7 to byte 6=5+1, where byte is counted from bottom to top). P1 makes the L2.5 MRH to contain the number of branches from P2 in 1 byte and the information about the links on the sub-trees/branches from P2 in 2 bytes. P1 sets the DA of the packet copy to the P2's MAC address, sets the SA of the packet copy to the P1's MAC address, and sends the packet copy to P2. The packet copy received by P2 is shown in FIG. 10B.

For the second downstream link from P1 (i.e., link from P1 to P3), P1 duplicates the packet for the link, sets HL to 6 (which is the value 5 of the S-Branches field for the link from P1 to P3 plus 1, where 1 (byte) is the size of the space/memory for storing the number of branches from P3). The information about the links on the sub-trees/branches from next hop node P3 is in the area from 5 (to 1). P1 makes the L2.5 MRH to contain the number of branches from P3 in 1 byte and the information about the links on the sub-trees/branches from P3 in 5 bytes. P1 sets the DA of the packet copy to the P3's MAC address, sets the SA of the packet copy to the P1's MAC address, and sends the packet copy to P3. The packet copy received by P3 is illustrated in FIG. 10C.

The procedure or behavior on an egress node of a P2MP path is discussed.

When an egress node of a P2MP path receives a packet transported by the P2MP path, the DA is the address of the egress node and there is an indication in the MRH for the leaf/egress.

In a first embodiment, the DA of the packet is the MAC address of the egress node and the MRH is a L2.5 MRH. The L2.5 MRH has HL=0. In this case, the egress node decapsulates the packet and sends the IP multicast datagram to the IP multicast forwarding module.

For example, after receiving the packet from P2, PE3 determines whether there is a L2.5 MRH with HL=0. If so, PE3 decapsulates the packet and sends the IP multicast datagram to the IP multicast forwarding module.

In a second embodiment, the DA of the packet is the IPV6 address of the egress node and the MRH is a L3 MRH. In one embodiment, the L3 MRH has SL=0.

For example, after receiving the packet from P2, PE3 determines whether the packet's next header is an MRH. When the packet's next header is the MRH, PE3 checks whether PE3 itself is a leaf (i.e., egress) through checking whether SL is 0. When PE3 is a leaf, PE3 decapsulates the packet and sends the IP multicast datagram to the IP multicast forwarding module.

The techniques disclosed herein can be deployed in any router and switch, which are used by the service providers around the world, to improve network scalability and/or efficiency.

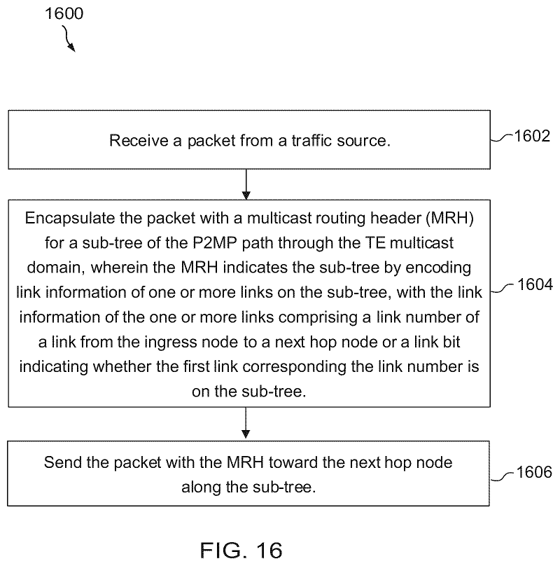

FIG. 16 is a method 1600 implemented by an ingress node in the TE multicast domain along a P2MP path according to an embodiment of the disclosure. The method 1600 may be performed to route a packet through a TE multicast domain along a P2MP path.

In block 1602, the ingress node receives a packet from a traffic source. In block 1604, the ingress node encapsulates the packet with an MRH for a sub-tree of the P2MP path through the TE multicast domain. In an embodiment, the sub-tree is encoded using link information of a link from the ingress node to a next hop node along the sub-tree. The MRH indicates the sub-tree by encoding link information of one or more links on the sub-tree, wherein the link information may include link number(s) of the one or more links or one or more link bits corresponding to respective link numbers and indicating whether links corresponding to the respective link numbers are on the sub-tree. The MRH may include link number (Link-No) field for indicating the link number(s) and a link bits field.

In block 1606, the ingress node sends the packet toward the next hop node along the sub-tree.

In an embodiment, the method 1600 further comprises determining address of the next hop node from a neighbor address table using the link number of the link, wherein the neighbor address table comprises the address of the next hop node that is a media access control (MAC) address or an Internet Protocol (IP) version 6 (IPv6) address.

In an embodiment, the MRH comprises at least one of a link number (Link-No) field for indicating the link number of the link or a link bits field having link bits corresponding to respective link numbers of links, and wherein the link bits indicate whether the links corresponding to the respective link numbers are on the sub-tree.

In an embodiment, the MRH further comprises at least one of a number of branches (N-Branches) field for indicating the number of branches from the next hop node of the link along the sub-tree, a size of branches (S-Branches) field, or a field for indicating a pointer pointing to the sub-tree.

In an embodiment, the MRH further comprises an L flag indicating whether the next hop node of the link is a leaf node.

In an embodiment, the MRH further comprises a B flag with a value indicating that the link bits are used to represent the link information

In an embodiment, the MRH comprises a flag with a value indicating the link directly from a root of the sub-tree is encoded by the link bits.

In an embodiment, the link bits field comprises a Bits field having multiple bits corresponding to respective link numbers, a Plus (P) field with a value indicating that a bit with a first value in the Bits field means a corresponding link is on a branch and the next hop node is a leaf node, and a size of the bits (S-Bits) field indicating a size of the Bits field in a unit.

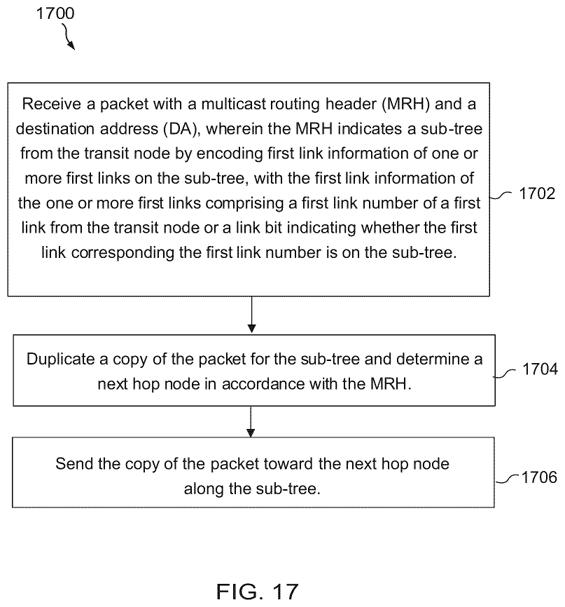

FIG. 17 is a method 1700 implemented by a transit node in the TE multicast domain along a P2MP path according to an embodiment of the disclosure.

The method 1700 may be performed to route a packet through a TE multicast domain along a P2MP path.

In block 1702, the transit node receives a packet with an MRH and a destination address (DA). In an embodiment, the MRH indicates a sub-tree from the transit node and may include link information of one or more links on the sub-tree. The MRH may include multiple fields for storing or indicating the link information. For example, the MRH may include a link number (Link-No) field for storing or indicating a link number, a number of branches (N-Branches) field for storing or indicating the number of branches of the sub-trees from the transit node, and a size of branches (S-Branches) field for storing or indicating a size of the branches the size of branches of the sub-tree/tree from the next hop node and/plus the fields following. In another embodiment, the S-Branches field may indicate a start of the branches of the sub-trees.

In block 1704, the transit node duplicates a copy of the packet for the sub-tree and determining a next hop node in accordance with the MRH. In an embodiment, the method 1704 further comprises determining a next node in accordance with the MRH. For example, the transit node may determine an address of the next hop node from a neighbor address table by using a link number of a link from the transit node to the next hop node. Then, the transmit node may set a DA of the copy of the packet to the address of the next hop node. The address of the next hop node may be a MAC address or IPv6 address. The neighbor address table includes a MAC address table or a neighbor IPv6 address table. In another embodiment, the transit node may update the MRH and sends the copy of packet with the updated MRH. The details of updating the MRH are as described above.

In block 1706, sending the copy of the packet toward the next hop node along the sub-tree.

In an embodiment, the MRH comprises at least one of a link number (Link No) field for indicating a link number of a link or a link bits field having multiple bits corresponding to respective link numbers of links, and wherein the multiple bits indicate whether the links corresponding to the respective link numbers are on the sub-tree.

In an embodiment, the MRH further comprises at least one of a number of branches (N-Branches) field for indicating the number of branches, a size of branches (S-Branches) field, or a field for indicating a pointer pointing to the sub-tree.

In an embodiment, the MRH comprises an L flag with a value indicating that the next hop node is a leaf node and has no corresponding N-Branches field and corresponding S-Branches field.

In an embodiment, the first link information further includes a B flag, and wherein the B flag with a value indicates that link bits of the link bits field are used to represent the link information.

In an embodiment, the link bits field comprises a Bits field having multiple bits corresponding to respective link numbers, a Plus (P) field with a value indicating that a bit with a first value in the Bits field means a corresponding link is on a branch and the next hop node is a leaf node, and a size of the bits (S-Bits) field with a value indicating a size of the Bits field in a unit.

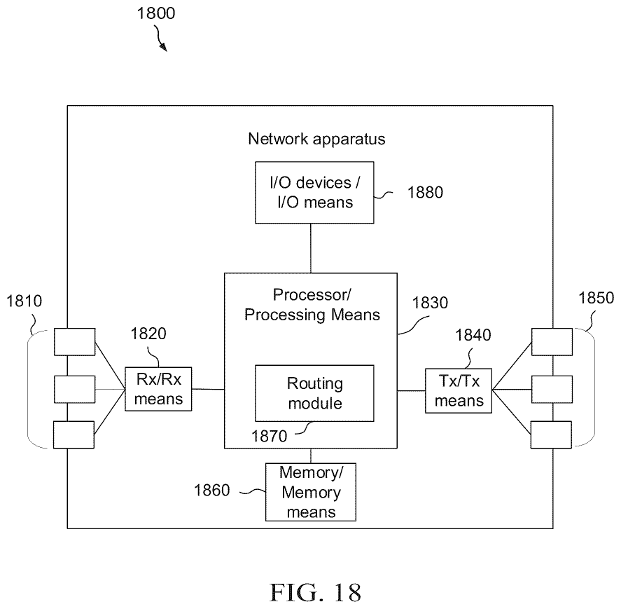

FIG. 18 is a schematic diagram of a network apparatus 1800 (e.g., an ingress node, a transit node, etc.) according to an embodiment of the disclosure. The network apparatus 1800 is suitable for implementing the disclosed embodiments as described herein. The network apparatus 1800 comprises ingress ports/ingress means 1810 (a.k.a., upstream ports) and receiver units (Rx)/receiving means 1820 for receiving data; a processor, logic unit, or central processing unit (CPU)/processing means 1830 to process the data; transmitter units (Tx)/transmitting means 1840 and egress ports/egress means 1850 (a.k.a., downstream ports) for transmitting the data; and a memory/memory means 1860 for storing the data. The network apparatus 1800 may also comprise optical-to-electrical (OE) components and electrical-to-optical (EO) components coupled to the ingress ports/ingress means 1810, the receiver units/receiving means 1820, the transmitter units/transmitting means 1840, and the egress ports/egress means 1450 for egress or ingress of optical or electrical signals.

The processor/processing means 1830 is implemented by hardware and software. The processor/processing means 1830 may be implemented as one or more CPU chips, cores (e.g., as a multi-core processor), field-programmable gate arrays (FPGAs), application specific integrated circuits (ASICs), and digital signal processors (DSPs). The processor/processing means 1830 is in communication with the ingress ports/ingress means 1810, receiver units/receiving means 1820, transmitter units/transmitting means 1840, egress ports/egress means 1850, and memory/memory means 1860. The processor/processing means 1830 comprises a routing module 1870. The routing module 1870 is able to implement the methods disclosed herein. The inclusion of the routing module 1870 therefore provides a substantial improvement to the functionality of the network apparatus 1800 and effects a transformation of the network apparatus 1800 to a different state. Alternatively, the routing module 1870 is implemented as instructions stored in the memory/memory means 1860 and executed by the processor/processing means 1830.

The network apparatus 1800 may also include input and/or output (I/O) devices or I/O means 1880 for communicating data to and from a user. The I/O devices or I/O means 1880 may include output devices such as a display for displaying video data, speakers for outputting audio data, etc. The I/O devices or I/O means 1880 may also include input devices, such as a keyboard, mouse, trackball, etc., and/or corresponding interfaces for interacting with such output devices.

The memory/memory means 1860 comprises one or more disks, tape drives, and solid-state drives and may be used as an over-flow data storage device, to store programs when such programs are selected for execution, and to store instructions and data that are read during program execution. The memory/memory means 1860 may be volatile and/or non-volatile and may be read-only memory (ROM), random access memory (RAM), ternary content-addressable memory (TCAM), and/or static random-access memory (SRAM).

While several embodiments have been provided in the present disclosure, it may be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, components, techniques, or methods without departing from the scope of the present disclosure. Other examples of changes, substitutions, and alterations are ascertainable by one skilled in the art and may be made without departing from the spirit and scope disclosed herein.

What is claimed is:

1. A method implemented by an ingress node in a traffic engineering (TE) multicast domain along a point-to-multipoint (P2MP) path, comprising:
receiving a packet from a traffic source;
encapsulating the packet with a multicast routing header (MRH) for a sub-tree of the P2MP path through the TE multicast domain, wherein the MRH indicates the sub-tree by encoding link information of one or more links on the sub-tree, wherein the link information of the one or more links comprises a link number of a link from the ingress node to a next hop node or a link bit indicating whether the link corresponding the link number is on the sub-tree; and
sending the packet with the MRH toward the next hop node along the sub-tree.

2. The method of claim 1, further comprising determining address of the next hop node from a neighbor address table using the link number of the link, wherein the neighbor address table comprises the address of the next hop node that is a media access control (MAC) address or an Internet Protocol (IP) version 6 (IPv6) address.

3. The method of claim 1, wherein the MRH comprises at least one of a link number (Link-No) field for indicating the link number of the link or a link bits field having link bits corresponding to respective link numbers of links, and wherein the link bits indicate whether the links corresponding to the respective link numbers are on the sub-tree.

4. The method of claim 3, wherein the MRH further comprises at least one of a number of branches (N-Branches) field for indicating the number of branches from the next hop node of the link along the sub-tree, a size of branches (S-Branches) field, or a field for indicating a pointer pointing to the sub-tree.

5. The method of claim 3, wherein the MRH further comprises an L flag indicating whether the next hop node of the link is a leaf node.

6. The method of claim 3, wherein the MRH further comprises a B flag with a value indicating that the link bits are used to represent the link information.

7. The method of claim 3, wherein the MRH further comprises a flag with a value indicating the link directly from a root of the sub-tree is encoded by the link bits.

8. The method of claim 3, wherein the link bits field comprises a Bits field having multiple bits corresponding to respective link numbers, a Plus (P) field with a value indicating that a bit with a first value in the Bits field means a corresponding link is on a branch and the next hop node is a leaf node, and a size of the bits (S-Bits) field indicating a size of the Bits field in a unit.

9. A method implemented by a transit node in a traffic engineering (TE) multicast domain along a point-to-multipoint (P2MP) path, comprising:
receiving a packet with a multicast routing header (MRH) and a destination address (DA), wherein the MRH indicates a sub-tree from the transit node by encoding first link information of one or more first links on the sub-tree, wherein the first link information of the one or more first links comprises a first link number of a first link from the transit node or a link bit indicating whether the first link corresponding the first link number is on the sub-tree;
duplicating a copy of the packet for the sub-tree and determining a next hop node in accordance with the MRH; and
sending the copy of the packet toward the next hop node along the sub-tree.

10. The method of claim 9, wherein sending the copy of the packet toward the next hop node along the sub-tree comprises sending the copy of the packet with an updated MRH toward the next hop node along the sub-tree, with the updated MRH comprising second link information of one or more second links determined in accordance with the MRH.

11. The method of claim 9, further comprising setting a DA of the copy of the packet to address of the next hop node from a neighbor address table using the first link number of the first link from the transit node to the next hop node, wherein the neighbor address table comprises the address of the next hop node that is a media access control (MAC) address or an Internet Protocol (IP) version 6 (IPv6) address.

12. The method of claim 9, wherein the MRH comprises at least one of a link number (Link No) field for indicating a link number of a link or a link bits field having multiple bits corresponding to respective link numbers of links, wherein the multiple bits indicate whether the links corresponding to the respective link numbers are on the sub-tree.

13. The method of claim 12, wherein the MRH further comprises at least one of a number of branches (N-Branches) field for indicating the number of branches, a size of branches (S-Branches) field, or a field for indicating a pointer pointing to the sub-tree.

14. The method of claim 13, wherein the MRH further comprises an L flag with a value indicating that the next hop node is a leaf node and has no corresponding N-Branches field and corresponding S-Branches field.

15. The method of claim 12, wherein the first link information further includes a B flag with a value indicating that link bits of the link bits field are used to represent the link information.

16. The method of claim 12, wherein the link bits field comprises a Bits field having multiple bits corresponding to respective link numbers, a Plus (P) field with a value indicating that a bit with a first value in the Bits field means a corresponding link is on a branch and the next hop node is a leaf node, and a size of the bits (S-Bits) field with a value indicating a size of the Bits field in a unit.

17. An ingress node, comprising:
a memory storing instructions; and
one or more processors coupled to the memory and configured to execute the instructions to cause the ingress node to:
receive a packet from a traffic source;
encapsulate the packet with a multicast routing header (MRH) for a sub-tree of a point-to-multipoint (P2MP) path through a traffic engineering (TE) multicast domain, wherein the MRH indicates the sub-tree by encoding link information of one or more links on the sub-tree, wherein the link information of the one or more links comprises a link number of a link from the ingress node to a next hop node or a link bit indicating whether the link corresponding the link number is on the sub-tree; and
send the packet with the MRH toward the next hop node along the sub-tree.

18. The ingress node of claim 17, wherein the MRH comprises at least one of a link number (Link-No) field for indicating the link number of the link or a link bits field having link bits corresponding to respective link numbers of links, and wherein the link bits indicate whether the links corresponding to the respective link numbers are on the sub-tree.

19. The ingress node of claim 18, wherein the MRH further comprises at least one of a number of branches (N-Branches) field for indicating the number of branches from the next hop node of the link along the sub-tree, a size of branches (S-Branches) field, or a field for indicating a pointer pointing to the sub-tree.

20. The ingress node of claim 18, wherein the MRH further comprises an L flag indicating whether the next hop node of the link is a leaf node and a B flag with a value indicating that the link bits are used to represent the link information.
